(19) United States
(12) Patent Application Publication
(10) Pub. No.: US 2025/0071653 A1
(43) Pub. Date: Feb. 27, 2025

(54) METHOD OF COMMUNICATION APPARATUS, METHOD OF USER EQUIPMENT (UE), COMMUNICATION APPARATUS, AND UE

(71) Applicant: NEC Corporation, Minato-ku, Tokyo (JP)

(72) Inventors: Iskren Ianev, Tokyo (JP); Toshiyuki Tamura, Tokyo (JP); Kundan Tiwari, Tokyo (JP)

(73) Assignee: NEC Corporation, Minato-ku, Tokyo (JP)

(21) Appl. No.: 18/724,253

(22) PCT Filed: Jan. 17, 2023
(86) PCT No.: PCT/JP2023/001077

§ 371 Date: Jun. 26, 2024

(30) Foreign Application Priority Data
Jan. 27, 2022 (IN) 202211004542

(51) Int. Cl. H04W 40/02; H04W 40/24; H04W 76/10

(52) U.S. Cl. CPC H04W 40/02; H04W 40/24; H04W 76/10

(57) ABSTRACT

In the current standard(s), there is no mechanism or procedure to achieve the objective. This disclosure provides a solution to this objective. A method of a communication apparatus includes sending information for requesting a URSP (User Equipment Route Selection Policy) rule, and receiving the URSP rule in a case of sending the information.

### TECHNICAL FIELD

This present disclosure relates to a method of a communication apparatus, a method of a User Equipment (UE), a communication apparatus, and a UE.

### BACKGROUND ART

In SA Plenary #94e meeting, NPL 2 Study on Enhancement of 5G UE Policy has been agreed as new study item in 3GPP Release 18. This Study includes the following objective.
#4 Investigate whether and how the network can be made aware when the UE enforces URSP rule and investigate whether and what actions the 5G network can perform.

### CITATION LIST

### Non Patent Literature

[NPL 1] 3GPP TR 21.905: “Vocabulary for 3GPP Specifications”. V17.1.0 (2021-12)

[NPL 2] SP-211641 “Study on Enhancement of Network Slicing Phase 3” https://www.3gpp.org/ftp/tsg_sa/TSG_SA/TSGS_94E_Electronic_2 021_12/Docs/SP-211641.zip

[NPL 3] 3GPP TS 24.526: “User Equipment (UE) policies for 5G System (5GS) Stage 3”. V17.5.0 (2021-12)

[NPL 4] 3GPP TS 23.501: “System architecture for the 5G System (5GS)”. V17.3.0 (2021-12)

[NPL 5] 3GPP TS 23.502: “Procedures for the 5G System (5GS)”. V17.3.0 (2021-12)

[NPL 6] 3GPP TS 23.503: “Policy and charging control framework for the 5G System (5GS) Stage 2”. V17.3.0 (2021-12)

[NPL 7] IETF RFC 5580: “Carrying Location Objects in RADIUS and Diameter”. (2009-08)

### SUMMARY OF INVENTION

### Technical Problem

In the current standard(s), there is no mechanism or procedure to achieve the objective. This disclosure provides a solution to this objective.

### Solution to Problem

In an aspect of the present disclosure, a method of a communication apparatus includes sending information for requesting a URSP (User Equipment Route Selection Policy) rule, and receiving the URSP rule in a case of sending the information.

In an aspect of the present disclosure, a method of a User Equipment (UE) includes receiving information for requesting a URSP (User Equipment Route Selection Policy) rule, and sending the URSP rule in a case of receiving the information.

In an aspect of the present disclosure, a method of a communication apparatus includes receiving information for requesting a URSP (User Equipment Route Selection Policy) rule, and sending the URSP rule in a case of receiving the information.

In an aspect of the present disclosure, a method of a communication apparatus includes sending information to request monitoring of a traffic routing, and receiving a result of the monitoring of the traffic routing in a case of sending the information.

In an aspect of the present disclosure, a method of a communication apparatus includes receiving information to request monitoring of a traffic routing, performing validity check for a URSP (User Equipment Route Selection Policy) rule after receiving the information, and sending information to monitor the traffic routing in a case where the validity check completes successfully.

In an aspect of the present disclosure, a method of a communication apparatus includes receiving information to monitor a traffic routing, monitoring the traffic routing based on the information, and sending a result of the monitoring of the traffic routing.

In an aspect of the present disclosure, a method of a communication apparatus includes receiving a result of a monitoring of a traffic routing, and sending the result.

In an aspect of the present disclosure, a method of a User Equipment (UE) includes sending a Protocol Data Unit (PDU) Session Establishment Request message. The PDU Session Establishment Request message includes Data Network Name (DNN), Single Network Slice Selection Assistance Information (S-NSSAI) and identifier of an application that the UE requests a service. The method includes receiving a PDU Session Establishment Reject message. The PDU Session Establishment Reject message includes a reject cause indicating that the UE or the application is not entitled for the service on the S-NSSAI and the DNN.

In an aspect of the present disclosure, a communication apparatus includes means for sending information for requesting a URSP (User Equipment Route Selection Policy) rule, and means for receiving the URSP rule in a case of sending the information.

In an aspect of the present disclosure, a User Equipment (UE) includes means for receiving information for requesting a URSP (User Equipment Route Selection Policy) rule, and means for sending the URSP rule in a case of receiving the information.

In an aspect of the present disclosure, a communication apparatus includes means for receiving information for requesting a URSP (User Equipment Route Selection Policy) rule, and means for sending the URSP rule in a case of receiving the information.

In an aspect of the present disclosure, a communication apparatus includes means for sending information to request monitoring of a traffic routing, and means for receiving a result of the monitoring of the traffic routing in a case of sending the information.

In an aspect of the present disclosure, a communication apparatus includes means for receiving information to request monitoring of a traffic routing, means for performing validity check for a URSP (User Equipment Route Selection Policy) rule after receiving the information, and means for sending information to monitor the traffic routing in a case where the validity check completes successfully.

In an aspect of the present disclosure, a communication apparatus includes means for receiving information to monitor a traffic routing, means for monitoring the traffic routing based on the information, and means for sending a result of the monitoring of the traffic routing.

In an aspect of the present disclosure, a communication apparatus includes means for receiving a result of a monitoring of a traffic routing, and means for sending the result.

In an aspect of the present disclosure, a User Equipment (UE) includes means for sending a Protocol Data Unit (PDU) Session Establishment Request message. The PDU Session Establishment Request message includes Data Network Name (DNN), Single Network Slice Selection Assistance Information (S-NSSAI) and identifier of an application that the UE requests a service, The UE includes means for receiving a PDU Session Establishment Reject message. The PDU Session Establishment Reject message includes a reject cause indicating that the UE or the application is not entitled for the service on the S-NSSAI and the DNN.

### BRIEF DESCRIPTION OF DRAWINGS

FIG. 1 is a signaling diagram of a First example of a First Aspect (UE policy enquiry from Application Function).

FIG. 2 is a signaling diagram of a Second example of the First Aspect (UE policy enquiry from Application Function via NEF and AMF).

FIG. 3 is a signaling diagram of a Third example of the First Aspect (UE policy enquiry from Application Function via PCF).

FIG. 4 is a signaling diagram of a Fourth example of the First Aspect (UE policy obtained from PCF).

FIG. 5 is a signaling diagram of a First example of a Second Aspect (External application service monitoring via NWDAF).

FIG. 6 is a signaling diagram of a Second example of the Second Aspect (External application service monitoring via NSACF).

FIG. 7 is a diagram illustrating a system overview.

FIG. 8 is a block diagram illustrating a User equipment (UE).

FIG. 9 is a block diagram illustrating an (R)AN node.

FIG. 10 is a diagram illustrating System overview of (R)AN node based on O-RAN architecture.

FIG. 11 is a block diagram illustrating a Radio Unit (RU).

FIG. 12 is a block diagram illustrating a Distributed Unit (DU).

FIG. 13 is a block diagram illustrating a Centralized Unit (CU).

FIG. 14 is a block diagram illustrating an Access and Mobility Management Function (AMF).

FIG. 15 is a block diagram illustrating a Session Management Function (SMF).

FIG. 16 is a block diagram illustrating a User Plane Function (UPF).

FIG. 17 is a block diagram illustrating a Policy Control Function (PCF).

FIG. 18 is a block diagram illustrating an Authentication Server Function (AUSF).

FIG. 19 is a block diagram illustrating a Unified Data Management (UDM).

FIG. 20 is a block diagram illustrating a Network Data Analytics Function (NWDAF).

FIG. 21 is a block diagram illustrating a Network Exposure Function (NEF).

FIG. 22 is a block diagram illustrating a Network Slice Admission Control Function (NSACF).

FIG. 23 is a block diagram illustrating an Application Function (AF).

### DESCRIPTION OF EMBODIMENTS

### Abbreviations

For the purposes of the present document, the abbreviations given in NPL 1 and the following apply. An abbreviation defined in the present document takes precedence over the definition of the same abbreviation, if any, in NPL 1.
4G-GUTI 4G Globally Unique Temporary UE Identity
5GC 5G Core Network
5GLAN 5G Local Area Network
5GS 5G System
5G-AN 5G Access Network
5G-AN PDB 5G Access Network Packet Delay Budget
5G-EIR 5G-Equipment Identity Register
5G-GUTI 5G Globally Unique Temporary Identifier
5G-BRG 5G Broadband Residential Gateway
5G-CRG 5G Cable Residential Gateway
5G GM 5G Grand Master
5G-RG 5G Residential Gateway
5G-S-TMSI 5G S-Temporary Mobile Subscription Identifier
5G VN 5G Virtual Network
5QI 5G QOS Identifier
AF Application Function
AMF Access and Mobility Management Function
AMF-G Geographically selected Access and Mobility Management Function
AMF-NG Non-Geographically selected Access and Mobility Management Function
ANDSF Access Network Discovery and Selection Function AS Access Stratum
ATSSS Access Traffic Steering, Switching, Splitting ATSSS-LL ATSSS Low-Layer
AUSF Authentication Server Function
AUTN Authentication token
BCCH Broadcast Control Channel
BMCABest Master Clock Algorithm
BSF Binding Support Function
CAG Closed Access Group
CAPIF Common API Framework for 3GPP northbound APIs
CHF Charging Function
CN PDB Core Network Packet Delay Budget
CP Control Plane
DAPS Dual Active Protocol Stacks
DL Downlink
DN Data Network
DNAI DN Access Identifier
DNN Data Network Name
DRX Discontinuous Reception
DS-TT Device-side TSN translator
ePDG evolved Packet Data Gateway
EBI EPS Bearer Identity
EPS Evolved Packet System
EUI Extended Unique Identifier
FAR Forwarding Action Rule
FN-BRG Fixed Network Broadband RG
FN-CRG Fixed Network Cable RG
FN-RG Fixed Network RG
FQDN Fully Qualified Domain Name
GFBR Guaranteed Flow Bit Rate
GMLC Gateway Mobile Location Centre
GPSI Generic Public Subscription Identifier
GUAMI Globally Unique AMF Identifier
GUTI Globally Unique Temporary UE Identity
HPLMN Home Public Land Mobile Network
HR Home Routed (roaming)
IAB Integrated access and backhaul
IMEI/TAC IMEI Type Allocation Code
IPUPS Inter PLMN UP Security
I-SMF Intermediate SMF
I-UPF Intermediate UPF
LADN Local Area Data Network
LBO Local Break Out (roaming)
LMF Location Management Function
LoA Level of Automation
LPP LTE Positioning Protocol
LRF Location Retrieval Function
MCC Mobile country code
MCX Mission Critical Service
MDBV Maximum Data Burst Volume
MFBR Maximum Flow Bit Rate
MICO Mobile Initiated Connection Only
MITM Man In the Middle
MNC Mobile Network Code
MPS Multimedia Priority Service
MPTCP Multi-Path TCP Protocol
N3IWF Non-3GPP InterWorking Function
N3GPP Non-3GPP access
N5CW Non-5G-Capable over WLAN
NAI Network Access Identifier
NAS Non-Access-Stratum
NEF Network Exposure Function
NF Network Function
NGAP Next Generation Application Protocol
NID Network identifier
NPN Non-Public Network
NR New Radio
NRF Network Repository Function
NSACF Network Slice Admission Control Function
NSI ID Network Slice Instance Identifier
NSSAA Network Slice-Specific Authentication and Authorization
NSSAAF Network Slice-Specific Authentication and Authorization Function
NSSAI Network Slice Selection Assistance Information
NSSF Network Slice Selection Function
NSSP Network Slice Selection Policy
NSSRG Network Slice Simultaneous Registration Group
NW-TT Network-side TSN translator
NWDAF Network Data Analytics Function
PCF Policy Control Function
PDB Packet Delay Budget
PDR Packet Detection Rule
PDU Protocol Data Unit
PEI Permanent Equipment Identifier
PER Packet Error Rate
PFD Packet Flow Description
PLMN Public Land Mobile Network
PNI-NPN Public Network Integrated Non-Public Network
PPD Paging Policy Differentiation
PPF Paging Proceed Flag
PPI Paging Policy Indicator
PSA PDU Session Anchor
PTP Precision Time Protocol
QFI QoS Flow Identifier
QoE Quality of Experience
RACS Radio Capabilities Signalling optimisation
(R)AN (Radio) Access Network
RAT Radio Access Technology
RG Residential Gateway
RIM Remote Interference Management
RQA Reflective QoS Attribute
RQI Reflective QoS Indication
RSN Redundancy Sequence Number
SA NR Standalone New Radio
SBA Service Based Architecture
SBI Service Based Interface
SCP Service Communication Proxy
SD Slice Differentiator
SEAF Security Anchor Functionality
SEPP Security Edge Protection Proxy
SMF Session Management Function
SMSF Short Message Service Function
SN Sequence Number
SN name Serving Network Name.
SNPN Stand-alone Non-Public Network
S-NSSAI Single Network Slice Selection Assistance Information
SSC Session and Service Continuity
SSCMSP Session and Service Continuity Mode Selection Policy
SST Slice/Service Type
SUCI Subscription Concealed Identifier
SUPI Subscription Permanent Identifier
SV Software Version
TMSI Temporary Mobile Subscriber Identity
TNAN Trusted Non-3GPP Access Network
TNAP Trusted Non-3GPP Access Point
TNGF Trusted Non-3GPP Gateway Function
TNL Transport Network Layer
TNLA Transport Network Layer Association
TSC Time Sensitive Communication
TSCAI TSC Assistance Information
TSN Time Sensitive Networking
TSN GM TSN Grand Master
TSP Traffic Steering Policy
TT TSN Translator
TWIF Trusted WLAN Interworking Function
UCMFUE radio Capability Management Function
UDM Unified Data Management
UDR Unified Data Repository
UDSF Unstructured Data Storage Function
UE User Equipment
UL Uplink
UL CL Uplink Classifier
UPF User Plane Function
URLLC Ultra Reliable Low Latency Communication
URRP-AMF UE Reachability Request Parameter for AMF
URSP UE Route Selection Policy
VID VLAN Identifier
VLAN Virtual Local Area Network
VPLMN Visited Public Land Mobile Network
W-5GAN Wireline 5G Access Network
W-5GBAN Wireline BBF Access Network
W-5GCAN Wireline 5G Cable Access Network
W-AGF Wireline Access Gateway Function

### Definitions

For the purposes of the present document, the terms and definitions given in NPL 1 and the following apply. A term defined in the present document takes precedence over the definition of the same term, if any, in NPL 1.

### <General>

Those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the Aspects of the present disclosure so as not to obscure the figures with details that will be readily apparent to those skilled in the art having the benefit of the description herein.

For the purpose of promoting an understanding of the principles of the disclosure, reference will now be made to the Aspect illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or entities or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an Aspect”, “in another Aspect” and similar language throughout this specification may, but not necessarily do, all refer to the same Aspect.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

As used herein, information is associated with data and knowledge, as data is meaningful information and represents the values attributed to parameters. Further knowledge signifies understanding of an abstract or concrete concept. Note that this example system is simplified to facilitate description of the disclosed subject matter and is not intended to limit the scope of this disclosure. Other devices, systems, and configurations may be used to implement the Aspects disclosed herein in addition to, or instead of, a system, and all such Aspects are contemplated as within the scope of the present disclosure.

Each of Aspects and elements included in each Aspects described below may be implemented independently or in combination with any other. These Aspects include novel characteristics different from one another. Accordingly, these Aspects contribute to achieving objects or solving problems different from one another and contribute to obtaining advantages different from one another.

It is assumed that a User Equipment (UE) knows all network slice(s) available within a cell in a VPLMN when the UE is in CM-IDLE state, CM-CONNECTED state or CM-CONNECTED with RRC Inactive state.

In the following aspects, a URSP rule may be included in a UE policy.

In the following aspects, a URSP rule may be expressed as a URSP policy or a UE policy.

An example object of this disclosure is to provide a method and apparatus that can solve the above problem.

A method of a communication apparatus according to example aspect of this disclosure includes sending information for requesting a URSP (User Equipment Route Selection Policy) rule. The method includes receiving the URSP rule in a case of sending the information.

A method of method of a User Equipment (UE) according to example aspect of this disclosure includes receiving information for requesting a URSP (User Equipment Route Selection Policy) rule. The method includes sending the URSP rule in a case of receiving the information.

A method of a communication apparatus according to example aspect of this disclosure includes receiving information for requesting a URSP (User Equipment Route Selection Policy) rule. The method includes sending the URSP rule in a case of receiving the information.

A method of a communication apparatus according to example aspect of this disclosure includes sending information to request monitoring of a traffic routing. The method includes receiving a result of the monitoring of the traffic routing in a case of sending the information.

A method of a communication apparatus according to example aspect of this disclosure includes receiving information to request monitoring of a traffic routing. The method includes performing validity check for a URSP (User Equipment Route Selection Policy) rule after receiving the information. The method includes sending information to monitor the traffic routing in a case where the validity check completes successfully.

A method of a communication apparatus according to example aspect of this disclosure includes receiving information to monitor a traffic routing. The method includes monitoring the traffic routing based on the information. The method includes sending a result of the monitoring of the traffic routing.

A method of a communication apparatus according to example aspect of this disclosure includes receiving a result of a monitoring of a traffic routing. The method includes sending the result.

A method of method of a User Equipment (UE) according to example aspect of this disclosure includes sending a Protocol Data Unit (PDU) Session Establishment Request message. The PDU Session Establishment Request message includes Data Network Name (DNN), Single Network Slice Selection Assistance Information (S-NSSAI) and identifier of an application that the UE requests a service. The method includes receiving a PDU Session Establishment Reject message. The PDU Session Establishment Reject message includes a reject cause indicating that the UE or the application is not entitled for the service on the S-NSSAI and the DNN.

A communication apparatus according to example aspect of this disclosure includes a memory, and at least one hardware processor coupled to the memory. The at least one hardware processor is configured to send information for requesting a URSP (User Equipment Route Selection Policy) rule. The at least one hardware processor is configured to receive the URSP rule in a case of sending the information.

A User Equipment (UE) according to example aspect of this disclosure includes a memory, and at least one hardware processor coupled to the memory. The at least one hardware processor is configured to receive information for requesting a URSP (User Equipment Route Selection Policy) rule. The at least one hardware processor is configured to send the URSP rule in a case of receiving the information.

A communication apparatus according to example aspect of this disclosure includes a memory, and at least one hardware processor coupled to the memory. The at least one hardware processor is configured to receive information for requesting a URSP (User Equipment Route Selection Policy) rule. The at least one hardware processor is configured to send the URSP rule in a case of receiving the information.

A communication apparatus according to example aspect of this disclosure includes a memory, and at least one hardware processor coupled to the memory. The at least one hardware processor is configured to send information to request monitoring of a traffic routing. The at least one hardware processor is configured to receive a result of the monitoring of the traffic routing in a case of sending the information.

A communication apparatus according to example aspect of this disclosure includes a memory, and at least one hardware processor coupled to the memory. The at least one hardware processor is configured to receive information to request monitoring of a traffic routing. The at least one hardware processor is configured to perform validity check for a URSP (User Equipment Route Selection Policy) rule after receiving the information. The at least one hardware processor is configured to send information to monitor the traffic routing in a case where the validity check completes successfully.

A communication apparatus according to example aspect of this disclosure includes a memory, and at least one hardware processor coupled to the memory. The at least one hardware processor is configured to receive information to monitor a traffic routing. The at least one hardware processor is configured to monitor the traffic routing based on the information. The at least one hardware processor is configured to send a result of the monitoring of the traffic routing.

A communication apparatus according to example aspect of this disclosure includes a memory, and at least one hardware processor coupled to the memory. The at least one hardware processor is configured to receive a result of a monitoring of a traffic routing. The at least one hardware processor is configured to send the result.

A User Equipment (UE) according to example aspect of this disclosure includes a memory, and at least one hardware processor coupled to the memory. The at least one hardware processor is configured to send a Protocol Data Unit (PDU) Session Establishment Request message. The PDU Session Establishment Request message includes Data Network Name (DNN), Single Network Slice Selection Assistance Information (S-NSSAI) and identifier of an application that the UE requests a service. The at least one hardware processor is configured to receive a PDU Session Establishment Reject message. The PDU Session Establishment Reject message includes a reject cause indicating that the UE or the application is not entitled for the service on the S-NSSAI and the DNN.

### First Aspect

In 5G deployment, the operator may restrict the usage of a specific network slice (e.g. based on the combination of S-NSSAI and DNN) to some specific third party Service Provider, which can be achieved by constructing the proper URSP rule at PCF and provisioning it to UE side, but currently the 5G network does not know whether the URSP is enforced by the UE. The network may need to be made aware when an application of a third-party Service Provider is routed using provisioned URSP rule(s).

In order to make third-party Service Provider possible to know which network slice (or URSP rule(s)) being used for their application, this aspect discloses a mechanism that makes it possible for the third-party Service Provider to enquire a network slice (or URSP rule(s)) being used in an operator network.

### First Example of the First Aspect

First example of the First Aspect discloses a method where an AF 201 provides a query request to a PLMN with an application identity in order to get a UE policy (e.g. a URSP rule). The UE policy may be used for network resource assignment for an indicated application by for example the AF 201. The PLMN uses an NWDAF 76 as a contact point of the query.

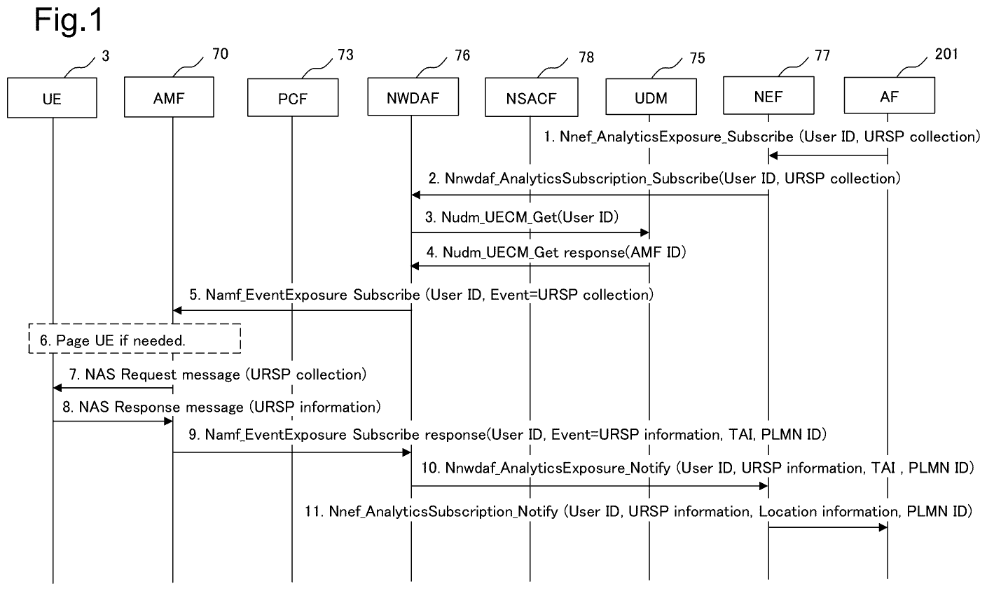

The detailed processes of the First example of the First Aspect are as described below. The detailed processes are shown in the FIG. 1.

Step 1. An AF 201 sends an Nnef_AnalyticsExposure_Subscribe message to an NEF 77 including User ID and URSP collection parameter(s). The User ID may be an identifier of the UE 3. The AF 201 may be controlled by the third-party Service Provider.

The URSP collection parameter(s) can be one or combination of the following parameters.
(List of) Application identifier (e.g. APL ID)
(List of) Application descriptor (e.g. OS Identifier (ID))
(List of) Application descriptor (e.g. OS ID+APL ID)
Event. Event indicates a request from the AF 201. For example, the Event may indicate information that the AF 201 requests. Event may be identified by Event ID. Event ID (or Event) can be one of the following parameters.
   URSP Policy in the UE
   Session status of the application.
   UE location

The Event ID may be included in the Nnef_AnalyticsExposure_Subscribe message. The Event ID may be included in the Nnef_AnalyticsExposure_Subscribe message instead of Event. The URSP Policy (e.g. a URSP rule) in the UE may correspond to the at least one of the Application identifier and the Application descriptor. For example, in a case where the AF 201 that controls Application 1 wants to know the URSP Policy for the Application 1, the AF 201 may include at least one of the Application identifier which identifies the Application 1 and the Application descriptor corresponds to the Application 1 in the Nnef_AnalyticsExposure_Subscribe message. In this case, the AF 201 may set corresponding parameter(s) to Event. For example, in a case where the AF 201 wants to know the URSP Policy for the Application 1, the AF 201 may include Event which is set to the URSP Policy in the Nnef_AnalyticsExposure_Subscribe message. For example, in a case where the AF 201 wants to know Session status of the Application 1, the AF 201 may include Event which is set to the Session status in the Nnef_AnalyticsExposure_Subscribe message. For example, in a case where the AF 201 wants to know UE location where the UE 3 runs the Application 1, the AF 201 may include Event which is set to the UE location in the Nnef_AnalyticsExposure_Subscribe message.

Step 2. Upon reception of the Nnef_AnalyticsExposure_Subscribe message from the AF 201, the NEF 77 sends an Nnwdaf_AnalyticsSubscription_Subscribe message to an NWDAF 76 including User ID and URSP collection parameter. The User ID and the URSP collection parameter in the Nnwdaf_AnalyticsSubscription_Subscribe message may be same to ones in the Nnef_AnalyticsExposure_Subscribe message.

Step 3. The NWDAF 76 sends an Nudm_UECM_Get message to a UDM 75 including the User ID to find an AMF that the UE 3 is associated with. Step 3 may be skipped in a case where the NWDAF 76 knows the AMF that the UE 3 is associated with.

Step 4. The UDM 75 sends an Nudm_UECM_Get response message to the NWDAF 76 including the AMF ID. The AMF ID may indicate the AMF that the UE 3 is associated with in this disclosure.

Step 5. The NWDAF 76 sends an Namf_EventExposure Subscribe message to an AMF 70 including the User ID and Event ID which is set to “URSP collection”. In this disclosure, the Event ID which is set to “URSP collection” may indicate the URSP collection parameter. The Namf_EventExposure Subscribe message may include an Event parameter including the URSP collection parameter. The Namf_EventExposure Subscribe message may include the Event parameter or the URSP collection parameter.

Step 6. In a case where the UE 3 is in the CM-Idle state in both 3GPP access and non-3GPP access, then the AMF 70 performs paging procedure over the 3GPP access to establish the connection with the UE 3 over the 3GPP access. For example, the AMF 70 may page the UE 3 identified by the received User ID.

Step 7. The AMF 70 sends a NAS Request message to the UE 3 including the URSP collection parameter. The NAS Request message may be a DL NAS transport message, a UE Configuration Update Command message, an Identity Request message or any other NAS message. Upon reception of the NAS Request message from the AMF 70, the UE 3 finds a relevant UE policy information (e.g. a URSP rule) and other requested information from the AMF 70 and stores them to URSP information parameter. For example, the UE 3 may find the relevant UE policy information and other requested information that correspond to the URSP collection parameter. The URSP information parameter may be expressed as URSP information or information related to a URSP rule or a URSP rule. For example, the AMF 70 may send the NAS Request message to the UE 3 identified by the received User ID.

Step 8. The UE 3 sends a NAS Response message to the AMF 70 including the URSP information parameter. The NAS Response message may be a UL NAS transport message, a UE Configuration Update Complete message, an Identity Response message or any NAS message. The URSP information parameter can be one or combination of the following parameters.
(List of) Route Selection Descriptors for designated application, i.e. both Route selection components and Route Selection Validation Criteria, that corresponds to the designated Application descriptor or the designated Application identifier. The Application identifier may be expressed as APL ID.
(List of) PDU session status of the designated application if the Event in the received URSP collection parameter indicates “Session status of the application”. A PDU session status can be whether PDU session for the designated application is established or not. If the PDU session is established, associated S-NSSAI, associated DNN, assigned IP address, access type either 3GPP access or Non-3GPP access, SSC mode and Session ID may be included in this parameter.

For example, in a case where the UE 3 receives the URSP collection parameter for the Application 1 (e.g. in a case where the Application identifier or the Application descriptor in the URSP collection parameter indicates the Application 1, or in a case where the UE 3 determines that the Application identifier or the Application descriptor in the URSP collection parameter is for the Application 1), the UE 3 sends the URSP information parameter for the Application 1. For example, in a case where the UE 3 receives the URSP collection for the Application 1, the UE 3 sends the URSP information parameter including the Route Selection Descriptors for the Application 1. In this case, if the URSP collection parameter indicates “Session status of the application”, the UE 3 includes the PDU session status of the Application 1 in the URSP information parameter. The PDU session status of the Application 1 may include S-NSSAI, DNN, IP address access type, SSC mode and Session ID that are related to the Application 1.

Step 9. The AMF 70 sends an Namf_EventExposure Subscribe response message to the NWDAF 76 including the User ID, the URSP information, TAI and PLMN ID. The TAI may be expressed as TAI information in this disclosure. The AMF 70 may include, in the Namf_EventExposure Subscribe response message, the TAI information where the UE 3 is located in a case where the Event in the received the URSP collection parameter in the Namf_EventExposure Subscribe message indicates “UE location”. The AMF 70 may include, in the Namf_EventExposure Subscribe response message, PLMN ID, either the PLMN name or PLMN Identification comprising MCC and MNC of the PLMN that the AMF 70 belongs to. The URSP information may be included in Event parameter of the Namf_EventExposure Subscribe response message. The User ID may be an identifier of the UE 3. The User ID may be same one as in the Namf_EventExposure Subscribe message. The URSP information may be same one as in the NAS Response message.

Step 10. The NWDAF 76 sends an Nnwdaf_EventExposure Notify message to the NEF 77 including the User ID, the TAI and the PLMN ID. The Nnwdaf_EventExposure Notify message may include the URSP information. The Nnwdaf_EventExposure Notify message may include the PLMN name or the PLMN Identification comprising MCC and MNC of the PLMN that the AMF 70 belongs to.

Step 11. The NEF 77 sends an Nnef_EventExposure Notify message to the AF 201 including the User ID, the URSP information, UE location information and the PLMN ID. When the NEF 77 receives the TAI information from the NWDAF 76 in the Nnwdaf_EventExposure Notify message, the NEF 77 converts the received TAI information to the UE location information including a general City name, zip-code, formed with GPS location or a location expressed with civic and geospatial location formats as defined in NPL 7. The Nnef_EventExposure Notify message may include the PLMN name or the PLMN Identification comprising MCC and MNC of the PLMN that the AMF 70 belongs to. The NEF 77 may send an Nnef_AnalyticsSubscription_Notify message including the User ID, the URSP information, the UE location information and the PLMN ID instead of the Nnef_EventExposure Notify message.

According to the above, for example, the 5G network and the third-party Service Provider (e.g. the AF 201) can know which network slice (or URSP rule(s)) are being used for their application in the operator network.

### Second Example of the First Aspect

Second example of the First Aspect discloses a method where an AF 201 provides a query request to the PLMN with an application identity in order to get a UE policy (e.g. URSP rule). The UE policy may be used for network resource assignment for an indicated application by AF 201, for example. The NEF 77 contacts to the AMF 70 for the query.

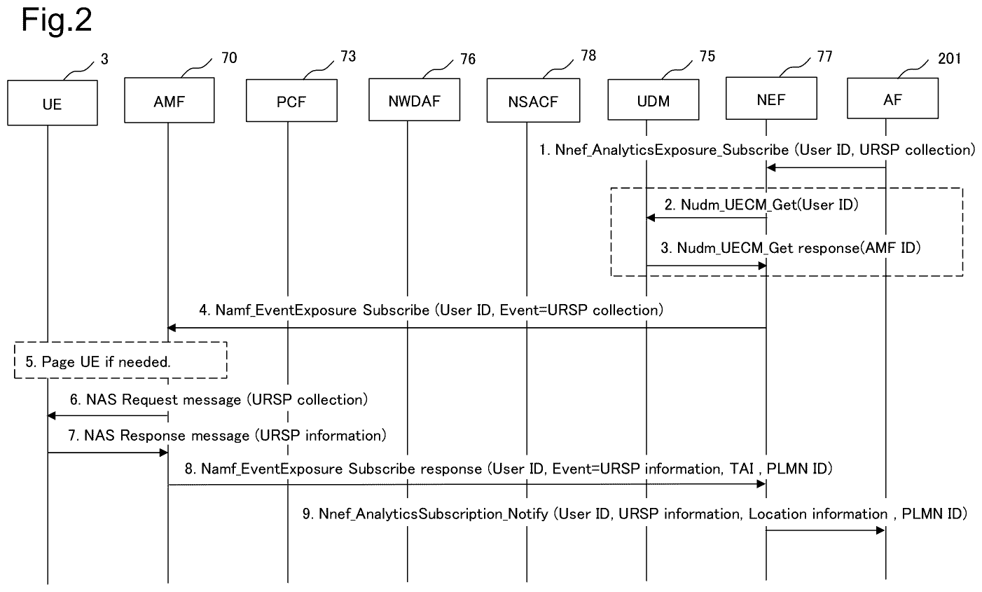

The detailed processes of the Second example of the First Aspect are as described below. The detailed processes are shown in the FIG. 2.

Step 1. It is the same as step 1 in FIG. 1.

Step 2. In a case where the NEF 77 does not know an AMF ID for a UE 3, the NEF 77 sends an Nudm_UECM_Get message to a UDM 75 including User ID of the UE 3 to find an AMF that the UE 3 is associated with. In a case where the NEF 77 knows the AMF that the UE 3 is associated with, step 2 may be skipped. Step 3. Upon reception of the Nudm_UECM_Get message, the UDM 75 sends an Nudm_UECM_Get response message to the NEF 77 including an AMF ID which identifies the AMF that the UE 3 is associated with.

Step 4. The NEF 77 sends an Namf_EventExposure Subscribe message to an AMF 70 including the User ID and Event ID which is set to “URSP collection”. The Namf_EventExposure Subscribe message may include an Event parameter including the URSP collection parameter. The Namf_EventExposure Subscribe message may include the Event parameter or the URSP collection parameter.

Step 5, Step 6 and Step 7 are the same as Step 6, Step 7 and Step 8 in the FIG. 1 respectively.

Step 8. The AMF 70 sends an Namf_EventExposure Subscribe response message to the NEF 77 including the User ID, the URSP information, TAI and PLMN ID. The AMF 70 may include, in the Namf_EventExposure Subscribe response message, the TAI information where the UE 3 is located in a case where the Event in the received URSP collection parameter in the Namf_EventExposure Subscribe message indicates “UE location”. The AMF 70 may include, in the Namf_EventExposure Subscribe response message, PLMN ID, either the PLMN name or PLMN Identification comprising MCC and MNC of the PLMN that the AMF 70 belongs to. The URSP information may be included in Event parameter of Namf_EventExposure Subscribe response message. The User ID may be an identifier of the UE 3. The User ID may be same one as in the Namf_EventExposure Subscribe message. The URSP information may be same one as in the NAS Response message.

Step 9. The NEF 77 sends an Nnef_EventExposure Notify message to the AF 201 including the User ID, the URSP information, UE location information and the PLMN ID. When the NEF 77 receives the TAI information from the AMF 70 in the Namf_EventExposure Subscribe response message, the NEF 77 converts the received TAI information to the UE location information including a general City name, zip-code, formed with GPS location or a location expressed with civic and geospatial location formats as defined in NPL 7. The Nnef_EventExposure Notify message may include the PLMN name or the PLMN Identification comprising MCC and MNC of the PLMN that the AMF 70 belongs to. The NEF 77 may send an Nnef_AnalyticsSubscription_Notify message including the User ID, the URSP information, the UE location information and the PLMN ID instead of the Nnef_EventExposure Notify message.

According to the above, for example, the 5G network and the third-party Service Provider (e.g. the AF 201) can know which network slice (or URSP rule(s)) being used for their application in the operator network.

### Third Example of the First Aspect

Third example of the First Aspect discloses a method where an AF 201 provides a query request to the PLMN with an application identity in order to get a UE policy (e.g. URSP rule). The UE policy may be used for network resource assignment for an indicated application by AF 201, for example. The PLMN uses a PCF 73 as a contact point for the query.

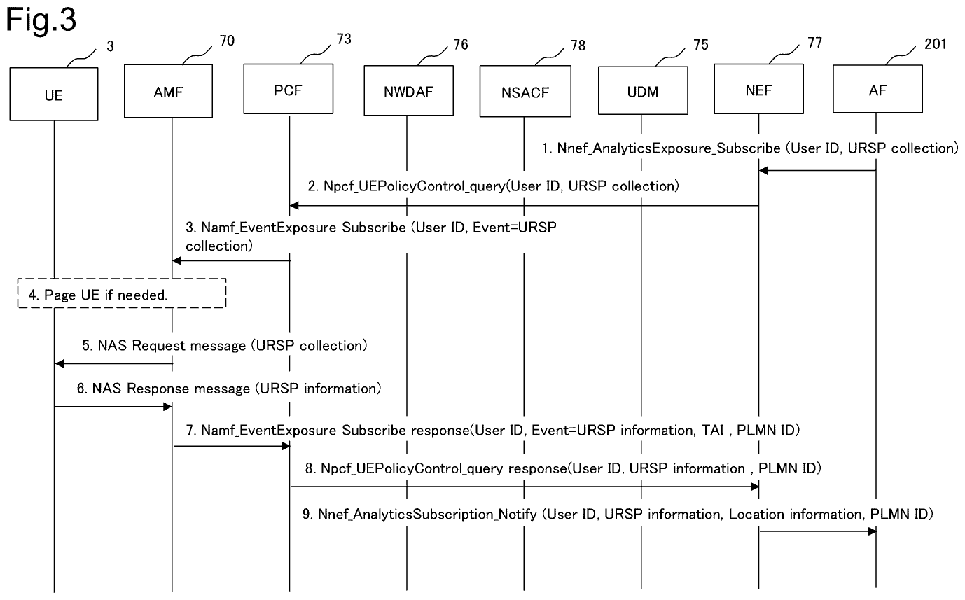

The detailed processes of the Third example of the First Aspect are as described below. The detailed processes are shown in the FIG. 3.

Step 1. It is same as the step 1 in FIG. 1.

Step 2. Upon reception of the Nnef_AnalyticsExposure_Subscribe message from the AF 201, the NEF 77 sends an Npcf_UEPolicyControl_query message or any other messages of the PCF service to a PCF 73 including the User ID and the URSP collection parameter.

Step 3. The PCF 73 sends an Namf_EventExposure Subscribe message to an AMF 70 including the User ID and Event ID which is set to “URSP collection”. The Namf_EventExposure Subscribe message may include an Event parameter including the URSP collection parameter. The Namf_EventExposure Subscribe message may include the Event parameter or the URSP collection parameter.

Step 4, Step 5 and Step 6 are same as Step 6, Step 7 and Step 8 in the FIG. 1 respectively.

Step 7. The AMF 70 sends an Namf_EventExposure Subscribe response message to the PCF 73 including the User ID, the URSP information, TAI and PLMN ID. The AMF 70 may include in the Namf_EventExposure Subscribe response message the TAI information where the UE 3 is located in a case where the Event in the received the URSP collection parameter in the Namf_EventExposure Subscribe message indicates “UE location”. The AMF 70 may include in the Namf_EventExposure Subscribe response message PLMN ID, either the PLMN name or PLMN Identification comprising MCC and MNC of the PLMN that the AMF 70 belongs to. The URSP information may be included in Event parameter of the Namf_EventExposure Subscribe response message. The User ID may be an identifier of the UE 3. The User ID may be same one as the one in the Namf_EventExposure Subscribe message. The URSP information may be same one as the one in the NAS Response message.

Step 8. The PCF 73 sends an Npcf_UEPolicyControl_query reply message or any other messages of the PCF service to the NEF 77 including the User ID, the URSP information, and the PLMN ID. The Npcf_UEPolicyControl_query reply message or any other messages of the PCF service may include the TAI. The Npcf_UEPolicyControl_query reply message or any other messages of the PCF service may include the PLMN name or PLMN Identification comprising MCC and MNC of the PLMN that the AMF 70 belongs to. The Npcf_UEPolicyControl_query reply message may be expressed as an Npcf_UEPolicyControl_query response message in this disclosure.

Step 9. The NEF 77 sends an Nnef_EventExposure Notify message to the AF 201 including the User ID, the URSP information, UE location information and the PLMN ID. When the NEF 77 receives the TAI information from the PCF 73 in the Npcf_UEPolicyControl_query reply message, the NEF 77 converts the received TAI to the UE location information including a general City name, zip-code, formed with GPS location or a location expressed with civic and geospatial location formats as defined in NPL 7. The Nnef_EventExposure Notify message may include the PLMN name or PLMN Identification comprising MCC and MNC of the PLMN that the AMF 70 belongs to. The NEF 77 may send an Nnef_AnalyticsSubscription_Notify message including the User ID, the URSP information, the UE location information and the PLMN ID instead of the Nnef_EventExposure Notify message.

According to the above, for example, the 5G network and the third-party Service Provider (e.g. the AF 201) can know which network slice (or URSP rule(s)) are being used for their application in the operator network.

### Variant 1 of Third Example of the First Aspect

### <AF Directly Contacts to PCF>

In this variant, the AF 201 directly contacts to the PCF 73 for UE policy query. The UE policy query may be expressed as URSP rule query in this disclosure. In this case, following replacements from FIG. 3 are applied.
Step 1 is replaced with an Npcf_UEPolicyControl_query message or any other messages of the PCF service from the AF 201 to the PCF 73. The Npcf_UEPolicyControl_query message includes the User ID and the URSP collection parameter.
Step 2 is voided.
Step 8 is replaced with an Npcf_UEPolicyControl_query response message or any other messages of the PCF service from the PCF 73 to the AF 201. The Npcf_UEPolicyControl_query response message including the User ID, the URSP information, the TAI or User location information (or UE location information) and PLMN ID. The TAI can be included if the TAI is comprehensible by the AF 201 as the AF 201 may be in the operator domain, otherwise, the PCF 73 converts the received TAI to the User location information (or the UE location information) including a general City name, zip-code, formed with GPS location or a location expressed with civic and geospatial location formats as defined in NPL 7.
Step 9 is voided.

### Fourth Example of the First Aspect

Fourth example of the First Aspect discloses a method where an AF 201 provides a query request to the PLMN with an application identity in order to get a UE policy (e.g. URSP rule). The UE policy may be used for network resource assignment for an indicated application by for example the AF 201. The PLMN obtains the UE policy from a PCF 73.

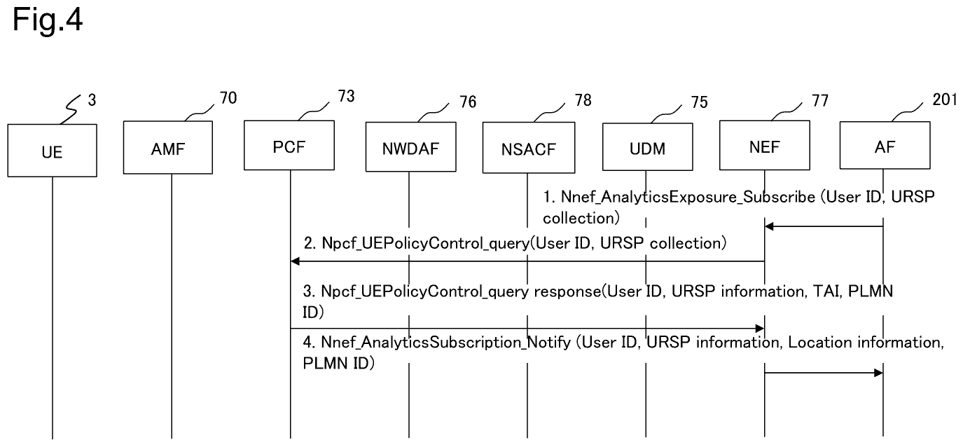

The detailed processes of the Fourth example of the First Aspect are as described below. The detailed processes are shown in the FIG. 4.
Step 1. It is same as step 1 in FIG. 1.
Step 2. It is same as step 2 in FIG. 3.
Step 3. Upon reception of the Npcf_UEPolicyControl_query message or any other messages of the PCF service from the NEF 77, the PCF 73 collects URSP policy for the UE 3 and the requested information by the URSP collection parameter. A TAI, in which the UE 3 is currently located, may be collected by the PCF 73 when the PCF 73 subscribes to a UE location related service provided by the AMF 70. The URSP policy for the UE 3 and the requested information may be expressed as URSP information. For example, the PCF 73 may collect the URSP policy for the UE 3 and the requested information by the URSP collection parameter based on the stored information in the PCF 73.

The PCF 73 sends an Npcf_UEPolicyControl_query reply message or any other messages of the PCF service to the NEF 77 including the User ID, the URSP information, the TAI and PLMN ID. The PCF 73 may include, in the Npcf_UEPolicyControl_query reply message or any other messages of the PCF service, PLMN ID, either the PLMN name or PLMN Identification comprising MCC and MNC of the PLMN that the PCF 73 belongs to.

Step 4. The NEF 77 sends an Nnef_EventExposure Notify message to the AF 201 including the User ID, the URSP information, UE location information and the PLMN ID. When the NEF 77 receives the TAI information from the PCF 73 in the Npcf_UEPolicyControl_query reply message or any other messages of the PCF service, the NEF 77 converts the received TAI information to the UE location information including a general City name, zip-code, formed with GPS location or a location expressed with civic and geospatial location formats as defined in NPL 7. Instead of the Nnef_EventExposure Notify message, the NEF 77 may send an Nnef_AnalyticsSubscription_Notify message to the AF 201 including the User ID, the URSP information, the UE location information and the PLMN ID. The Nnef_EventExposure Notify message may include either the PLMN name or the PLMN Identification comprising MCC and MNC of the PLMN that the PCF 73 belongs to.

According to the above, for example, the 5G network and the third-party Service Provider (e.g. the AF 201) can know which network slice (or URSP rule(s)) being used for their application in the operator network.

### Variant 1 of Fourth Example of the First Aspect

<AF directly contacts to PCF>

In this variant, the AF 201 directly contacts to the PCF 73 for UE policy query. In this case the following replacements from FIG. 4 are applied.
Step 1 is replaced with an Npcf_UEPolicyControl_query message or any other messages of the PCF service from the AF 201 to the PCF 73. The Npcf_UEPolicyControl_query message includes the User ID and the URSP collection parameter.
Step 2 is voided.
Step 3 is replaced with an Npcf_UEPolicyControl_query response message or any other messages of the PCF service from the PCF 73 to the AF 201. The Npcf_UEPolicyControl_query response message includes the URSP information parameter. The Npcf_UEPolicyControl_query response message may include the User ID. The TAI information can be set in the URSP information if the TAI can be comprehensible by the AF 201 as the AF 201 may be in the operator domain.
Step 4 is voided.

### Second Aspect

In 5G deployment, the operator may restrict the usage of a specific network slice (e.g. based on the combination of S-NSSAI and DNN) to some specific third party Service Provider, which can be achieved by constructing the proper URSP rule at PCF and provisioning it to UE side, but currently the 5G network does not know whether the URSP is enforced by the UE. The network may need to be made aware when an application of a third-party Service Provider is routed using provisioned URSP rule(s).

The Second Aspect discloses a method for monitoring and control by the 3GPP network the usage of the services provided by the external service providers, e.g. AF. For example, it allows the services on the S-NSSAI and DNN provided by the external service providers, to be used only by the UEs and Applications that are entitled for that service via the URSP rule(s) provided to the UEs.

### First Example of the Second Aspect

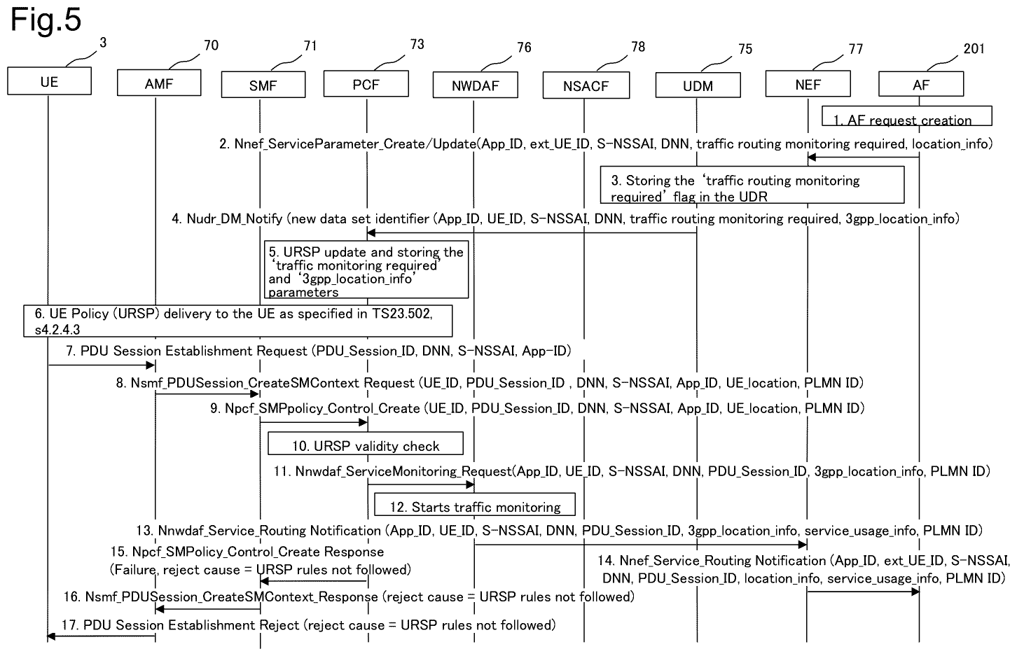

The First example of the Second Aspect in FIG. 5 proposes a solution for access control and monitoring for the services provided on the S-NSSAI and DNN by external service providers where the access control is performed by a PCF 73 and the monitoring is performed by an NWDAF 76.

The detailed processes of the First example of the Second Aspect are as described below.

Step 1. AF request creation—An AF 201 can provide service specific parameters to the 5G system via an NEF 77 as specified in Section 4.15.6.7 in NPL 5. The AF 201 may issue requests on behalf of an outside application owned or not owned by the PLMN serving the UE 3.

Step 2. The AF 201 sends an Nnef_ServiceParameter_Create/Update message to the NEF 77. The Nnef_ServiceParameter_Create/Update message includes App_ID, ext_UE_ID, S-NSSAI, DNN, and traffic routing monitoring required. The Nnef_ServiceParameter_Create/Update message may include location_info. The location_info may be expressed as location information. The App_ID may identify the service provider, i.e the AF 201. The ext_UE_ID may be in the form of GPSI or external Group Identity. The AF 201 includes, in the message, the S-NSSAI and the DNN to identify the service provided by the AF 201. The AF 201 may also include in the message to the NEF 77 a ‘traffic routing monitoring required’ parameter or any other notation for a parameter which identifies a request by the AF 201 to the 3GPP system for monitoring and control the access to services provided by the combination of the S-NSSAI and the DNN, e.g. whether at least one of a UE 3 and the application in a UE 3 which requests a service on at least one of the S-NSSAI and the DNN are entitled to this service by the URSP rule(s) for that UE 3. The ‘traffic routing monitoring required’ parameter may be expressed as ‘traffic routing monitoring required’ in this disclosure. The ‘traffic routing monitoring required’ parameter may be expressed as information to request monitoring of a traffic routing.

If the ‘traffic routing monitoring required’ parameter is included by the AF 201, the 3GPP system monitors and controls the use of the service provided by at least one of the S-NSSAI and the DNN. For example, the 3GPP system may reject services from applications and UE(s) that is not entitled for the service based on the latest URSP rule(s) provided to the UE by the 3GPP system. If a location_info parameter is included by the AF 201, the use of the service, e.g. PDU Session(s) on the S-NSSAI and the DNN may be monitored and controlled by the network only in the location(s) identified by the location_info parameter represented in geographical or any other manner.

Step 3. The NEF 77 stores the AF 201 requested information in the UDM 75 in the ‘Application data’ section and the NEF 77 also does some mapping like ext_UE_ID to 3GPP UE identity (for example GPSI to SUPI): Service Identity to S-NSSAI and DNN if the AF 201 has provided the service identity instead the S-NSSAI and the DNN. If the location_info is provided by the AF 201, the NEF 77 maps the provided location_info to 3GPP compatible location information e.g. 3gpp_location_info defined as one or more cells or one or more TAs. The NEF 77 also stores in the UDM 75 the ‘traffic routing monitoring required’ parameter. The NEF 77 may store the 3GPP compatible location information from the ‘3gpp_location_info’ parameter related to the UE_ID (e.g. SUPI), if provided by the AF 201. Alternatively, the ‘traffic routing monitoring required’ parameter and the ‘3gpp_location_info’ parameter may be stored in the UDM 75 by the network operator based on the SLA agreements with the external service providers, i.e. AF 201. The ‘traffic routing monitoring required’ parameter may be expressed as ‘traffic routing monitoring required’ flag in this disclosure. The NEF 77 may store the above information in the UDR.

Step 4. The UDM 75 sends an Nudr_DM_Notify message to the PCF 73 as per Session 5.2.12.2.1-1 in NPL 5. The Nudr_DM_Notify message may include the App_ID, the UE_ID, the S-NSSAI, the DNN, the traffic routing monitoring required, and the 3gpp_location_info. For example, if the UE 3 is registered to the network and a PCF 73 is subscribed for notifications by the UDM 75 when the application data for the UE 3 is modified, the UDM 75 may send the Nudr_DM_Notify message to the PCF 73. For example, if the information mentioned in the step 3 is stored in the UDM 75, e.g. in the UDR of the UDM 75. The UDR of the UDM 75 may send the Nudr_DM_Notify message to the PCF 73.

Step 5. The PCF 73 updates the UE Policy (i.e. the URSP rule(s)) for the UE 3 indicated by the Nudr_DM_Notify message from the UDM 75 and the PCF 73 stores the traffic monitoring required parameter and the 3gpp_location_info parameter within the PCC rule(s) in the PCF 73 for the UE 3. The PCF 73 may associate and store the App_ID, the UE_ID, the S-NSSAI, the DNN the traffic monitoring required parameter and the 3gpp_location_info parameter.

Step 6. The PCF 73 provides the updated UE Policy with the updated URSP rule(s) to the UE 3 via the UE Policy update procedure as per Section 4.2.4.3 in NPL 5.

Step 7. At some stage an application with App_ID in the UE 3 requests a service on at least one of S-NSSAI and DNN. In this case, the UE 3 sends a PDU Session Establishment Request message to an AMF 70. The UE 3 includes PDU_Session_ID, the DNN and the S-NSSAI in the PDU Session Establishment Request message. The UE 3 also includes a service application identity (i.e. App_ID) in the PDU Session Establishment Request message to the AMF 70. The service application identity may be expressed as App_ID in this disclosure. The App_ID may be Application identifier or OS identifier or a combination of the Application identifier and the OS identifier. This definition of the App_ID may be valid for entire Second Aspect in this disclosure. The App_ID may be expressed as App-ID in this disclosure. In this disclosure, the App_ID may be an identity of the application in the UE 3 that requests a service on at least one of the S-NSSAI and the DNN.

Step 8. The AMF 70 selects an SMF 71 as per the requirements in NPL 5 and sends an Nsmf_PDUSession_CreateSMContext Request message to the SMF 71. The AMF 70 includes, in the Nsmf_PDUSession_CreateSMContext Request message, the UE_ID and the PDU Session ID, the DNN and the S-NSSAI parameters received from the UE 3. The AMF 70 also includes the application identity (i.e. the App_ID), UE location and PLMN ID in the Nsmf_PDUSession_CreateSMContext Request message to the SMF 71.

The AMF 70 may include, in the Nsmf_PDUSession_CreateSMContext Request message, PLMN ID, either the PLMN name or PLMN Identification comprising MCC and MNC of the PLMN that the AMF 70 belongs to. The UE location may be expressed as UE_location information in this disclosure.

The UE location may indicate location information of the UE 3, for example TAI where the UE 3 locates. The UE location may not be included in the Nsmf_PDUSession_CreateSMContext Request message. The UE_ID may be an identifier of the UE 3.

Step 9. The SMF 71 triggers policy association with the PCF 73 and sends an Npcf_SMPpolicy_Control_Create message to the PCF 73. The SMF 71 includes, in the Npcf_SMPpolicy_Control_Create message as parameters the UE ID, the PDU_Session_ID, the DNN, the S-NSSAI and the PLMN ID received from the AMF 70. The SMF 71 also includes the App_ID and the UE_location information in the Npcf_SMPpolicy_Control_Create message to the PCF 73. If the UE_location information was provided to the SMF 71, the SMF 71 may include the UE_location information in the Npcf_SMPpolicy_Control_Create message.

Step 10. URSP validity check-If the PCF 73 does not have the subscriber's subscription related information, the PCF 73 sends a request to the UDM 75 by invoking Nudr_DM_Query service in order to receive the information related to the PDU Session_ID. The Nudr_DM_Query service or Nudr_DM_Query message may include SUPI (e.g. SUPI of the UE 3), the DNN, and the S-NSSAI. The PCF 73 may request notifications from the UDM 75 on changes in the subscription information by invoking Nudr_DM_Subscribe message as per Session 4.16.9 in NPL 5. The PCF 73 checks UE's URSP validity, i.e. whether the UE 3 or an application in the UE 3 is entitled for a service on the requested S-NSSAI and DNN. For example, the PCF 73 may check whether the application identity (i.e. the App_ID) in the UE 3 is allowed to be mapped with the S-NSSAI and DNN provided in the Npcf_SMPpolicy_Control_Create message from the SMF 71. The PCF 73 checks the PDU Session routing rule(s) for the UE 3 from the latest URSP rule(s) for that UE 3 which are stored in the PCF 73. To pass the URSP validity check, the App_ID mapping to the S-NSSAI and the DNN and optionally PDU_Session_ID within the URSP rules copy for UE 3 stored within the PCF 73 needs to match with the App_ID, the S-NSSAI and the DNN and optionally the PDU_Session_ID parameters provided from the AMF 70, i.e. the UE 3's URSP rules copy provided by the UE 3 and the UE 3's URSP rules copy stored in the PCF 73 need to match. If 3gpp_location_info is provided to the PCF 73, the PCF 73 checks whether the UE 3's location is within the location provided via the 3gpp_location_info. If the UE 3's location is outside of the location provided via the 3gpp_location_info, the UE 3 is not entitled for a service on the S-NSSAI and the DNN even if the App_ID requesting the service is mapped with the S-NSSAI and DNN (e.g. even if the URSP validity check passes). For example, the PCF 73 determines that the UE's URSP validity check passes (e.g. the PCF 73 determines that the UE 3's URSP rule(s) provided by the UE 3 matches with the UE 3's URSP rule(s) stored in the PCF 73 or the PCF 73 determines that combination of the App_ID, the S-NSSAI and the DNN and optionally the PDU Session_ID stored in the PCF 73 in step 5 matches with combination of the App_ID, the S-NSSAI and the DNN and optionally the PDU_Session_ID received from the AMF 70 via the SMF 71), the PCF 73 determines that the App_ID in the UE 3 is entitled for a service on the requested S-NSSAI and the DNN. If 3gpp_location_info is not provided to the PCF 73, the PCF 73 may skip checking whether the UE 3's location is within the location provided via the 3gpp_location_info.

Step 11. If the App_ID in the UE 3 and the UE 3 itself is entitled for a service on the requested S-NSSAI and the DNN as a result of the URSP validity check by the PCF 73 (e.g. the PCF 73 determines that the App_ID in the UE 3 is entitled for a service on the requested S-NSSAI and the DNN and optionally PDU Session_ID), the PCF 73 sends an Nnwdaf_ServiceMonitoring_Request message to the NWDAF 76. The PCF 73 includes the App_ID, the UE_ID, the S-NSSAI, the DNN, the 3gpp_location_info, the PLMN ID and optionally PDU Session_ID in the Nnwdaf_ServiceMonitoring_Request message. Alternatively, the PCF 73 may make use of any other existing or new message between the PCF 73 and the NWDAF 76 to convey the App_ID, the UE_ID, the S-NSSAI, the DNN, the 3gpp_location_info and the PLMN ID for the purpose of service usage monitoring on the S-NSSAI and the DNN and optionally the PDU_Session_ID. If the 3gpp_location_info is provided to the PCF 73, the PCF 73 may include the 3gpp_location_info in the Nnwdaf_ServiceMonitoring_Request message. In this disclosure, at least one of the App_ID, the UE_ID, the S-NSSAI, the DNN, the 3gpp_location_info, the PLMN ID and the PDU Session_ID may be collectively expressed as information to monitor a traffic routing.

Step 12. The NWDAF 76 starts monitoring the traffic routing on the S-NSSAI and the DNN by the App_ID in the UE 3 and optionally the PDU session with PDU_Session_ID, if provided. For example, the NWDAF 76 starts monitoring the traffic routing on the S-NSSAI and the DNN and optionally PDU_Session_ID that correspond to the App_ID provided by the PCF 73. If 3gpp_location_info is included by the PCF 73, the monitoring applies for the location defined in the 3gpp_location_info parameter. The location information may be defined in terms of one or more cells or one or more TAs. If the 3gpp_location_info parameter is provided by the PCF 73, the NWDAF 76 may subscribe for the UE 3's location tracking by the AMFs as per 3GPP TS23.288 so that the NWDAF 76 can monitor for the service access to the S-NSSAI and the DNN by the UE 3 only when the UE 3 is within the location defined by the 3gpp_location_info parameter.

Step 13. If the AF 201 is subscribed for traffic routing notifications with the NWDAF 76, the NWDAF 76 may trigger notifications to the NEF 77 each time a service on the S-NSSAI and the DNN is accessed. The NWDAF 77 sends an Nnwdaf_Service_Routing Notification message to the NEF 77. The NWDAF 76 includes, in the Nnwdaf_Service_Routing Notification message, the App_ID, the UE_ID, the S-NSSAI, the DNN, the PDU Session_ID, the 3gpp_location_info, the PLMN ID and service_usage_info which may include information about duration of the service access on the S-NSSAI and the DNN. Alternatively, the NWDAF 76 may make use of any other existing or new notification service or message between the NWDAF 76 and the NEF 77 to convey the App_ID, the UE_ID, the S-NSSAI, the DNN, the PDU Session_ID, the 3gpp_location_info, the PLMN ID and the service_usage_info to the NEF 77. If the 3gpp_location_info is provided to the NWDAF 76, the NWDAF 76 may include the 3gpp_location_info in the Nnwdaf_Service_Routing Notification message. For example, the NWDAF 77 may send the Nnwdaf_Service_Routing Notification message in a case where the NWDAF 77 detects the traffic routing on the S-NSSAI and the DNN and optionally on the PDU session with PDU_Session_ID that correspond to the App_ID. For example, the NWDAF 77 may send the Nnwdaf_Service_Routing Notification message in a case where the AF 201 is subscribed for traffic routing notifications with the NWDAF 76 and the NWDAF 77 detects the traffic routing on the S-NSSAI and the DNN and PDU session with PDU_Session_ID that correspond to the App_ID.

Step 14. The NEF 77 maps the UE_ID to ext_UE_ID, 3gpp_location_info to a geographical location_info and sends an Nnef_Service_Routing Notification message to the AF 201. The Nnef_Service_Routing Notification message may include the App_ID, the ext_UE_ID, the S-NSSAI, the DNN, the location_info (e.g. the geographical location_info), the service_usage_info, and the PLMN ID. Alternatively, the NEF 77 may make use of any other existing or new notification service or message between the NEF 77 and the AF 201 to convey the App_ID, the ext_UE_ID, the S-NSSAI, the DNN, the location_info and the service_usage_info to the AF 201. In this disclosure, at least one of the App_ID, the ext_UE_ID, the S-NSSAI, the DNN, the PDU_Session_ID, the location_info (e.g. the geographical location_info), the service_usage_info, and the PLMN ID may be collectively expressed as a result of a monitoring of a traffic routing.

Step 15. If at step 10 the URSP validity check fails, i.e. the PCF 73 decides that the application in the UE 3 that has requested service on the S-NSSAI and on the DNN is not entitled for service on that S-NSSAI and the DNN (e.g. the PCF 73 determines that the UE 3's URSP rule(s) provided by the UE 3 does not match with the UE 3's URSP rule(s) stored in the PCF 73 or the PCF 73 determines that the combination of the App_ID, the S-NSSAI and the DNN and optionally the PDU_Session_ID stored in the PCF 73 in step 5 does not match with combination of the App_ID, the S-NSSAI and the DNN and optionally the PDU_Session_ID received from the AMF 70 via the SMF 71), the PCF 73 returns an Npcf_SMPolicy_Control_Create Response message to the SMF 71. The PCF 73 includes, in the Npcf_SMPolicy_Control_Create Response message, a Failure result parameter and a reject cause. The reject cause may be set to ‘URSP rules not followed’ or any other notation for a reject cause which indicates that the UE 3 or an application on the UE 3 is not entitled for a service on the requested S-NSSAI and the DNN, e.g. the URSP rule(s) for the UE 3 do not allow mapping for the App_ID to the S-NSSAI and the DNN. The reason for the service mapping mismatch could be either the UE 3 does not have the latest URSP rule(s), i.e. URSP rule(s) mismatch between the URSP copies in the UE 3 and in the PCF 73, or the UE 3 does not follow the URSP rule(s).

Step 16. If the SMF 71 receives the Npcf_SMPolicy_Control_Create Response message from the PCF 73 with a Failure result and with the reject cause which is set to ‘URSP rules not followed’, the SMF 71 responds with an Nsmf_PDUSession_CreateSMContext_Response message to the AMF 70. The SMF 71 includes, in the Nsmf_PDUSession_CreateSMContext_Response message, the reject cause transmitted by the PCF 73.

Step 17. Upon reception of the Nsmf_PDUSession_CreateSMContext_Response message, the AMF 70 rejects the PDU Session establishment Request from the UE 3 by sending a PDU Session Establishment Reject message. The AMF 70 includes in the PDU Session Establishment Reject message a reject cause which is set to ‘URSP rules not followed’ or any other notation for a reject cause which indicates that the UE 3 or an application on the UE 3 is not entitled for a service on the requested S-NSSAI and the DNN, e.g. the URSP rule(s) for the UE 3 do not allow mapping for the App_ID to the S-NSSAI and the DNN.

When the UE 3 receives PDU Session Establishment Reject message with the reject cause which is set to ‘URSP rules not followed’, the UE 3 does not attempt another request for PDU Session establishment on the S-NSSAI and the DNN for which it was rejected until the UE 3 receives an update to the URSP rule(s) from the network. If the UE 3 continues being rejected multiple times (this number of times may be a 3GPP standardised value or it could be configured by configurations in the UE 3) with the same reject cause which is set to ‘URSP rules not followed’, the UE 3 does not attempt another PDU Session establishment request on the S-NSSAI and the DNN until the UE 3 re-registers.

According to the above, for example, the 5G network and the third-party Service Provider (e.g. the AF 201) can know when an application of a third-party Service Provider is routed using provisioned URSP rule(s).

### Variant 1 of the First Example of the Second Aspect

After step 7 in FIG. 5, before the AMF 70 selects the SMF 71 and the AMF 70 triggers the Nsmf_PDUSession_CreateSMContext Request message to the SMF 71, the AMF 70 may first interact with the PCF 73 in order to check if the App_ID from the UE 3 and the UE 3 are entitled for the requested service on the S-NSSAI and the DNN and optionally the PDU Session with PDU-Session_ID provided by the UE 3. For this the AMF 70 may make use of the UE Policy association procedure of the AMF 70 with the PCF 73 as defined in Section 4.16.11 in NPL 5. To establish the UE Policy association with the PCF 73, the AMF 70 sends an Npcf_UEPolicyControl_Create Request message to the PCF 73. Along with the parameters related to the policy association, the AMF 70 also includes the App_ID, the UE ID, the PDU_Session_ID, the S-NSSAI, the DNN and the UE_location in the Npcf_UEPolicyControl_Create Request. Based on these additional parameters provided by the AMF 70, the PCF 73 checks the PDU Session routing rules for the UE 3 from the latest URSP rules copy for that UE 3 which is stored in the PCF 73. To pass the URSP validity check, the App_ID mapping to the S-NSSAI and DNN within the URSP rules copy for UE 3 stored within the PCF 73 needs to match with the App_Id, S-NSSAI and DNN and optionally the PDU_Session_ID parameters provided from the AMF 70, i.e. the UE 3 URSP rules copy provided by the UE and the UE 3 URSP rules copy stored in the PCF 73 needs to match. If 3gpp_location_info was provided to the PCF 73, the PCF 73 checks whether the UE_location provide by the AMF 70 is within the location provided via the 3gpp_location_info. If the UE 3 location provided in the UE_location parameter from the AMF 70 is outside of the location provided via the 3gpp_location_info, the UE 3 is not entitled for a service on the S-NSSAI and the DNN even if the App_ID requesting the service is correctly mapped with the S-NSSAI and DNN. If the PCF 73 concludes that the App_ID on UE 3 is not entitled for service on the requested S-NSSAI and DNN and PDU Session with PDU_Session_ID, i.e. the URSP validity check fails, the PCF 73 returns an Npcf_UEPolicyControl_Create Response including a reject cause which is set to ‘URSP rules not follow’ to the AMF 70 and the AMF 70 rejects the PDU Session Establishment Request from the UE as per step 17 in FIG. 5. The URSP validity check may be performed in the same manner as the First example of the Second Aspect. If the PCF 73 concludes that the App_ID on UE 3 is entitled for service on the requested S-NSSAI and DNN and optionally PDU Session_ID, i.e. the URSP validity check completes successfully, the PCF 73 may return an Npcf_UEPolicyControl_Create Response including information indicating that the URSP validity check completes successfully. In this case, the AMF 70 may select the SMF 71 and the AMF 70 triggers the Nsmf_PDUSession_CreateSMContext Request message to the SMF 71 including the information indicating that the URSP validity check completes successfully along with the information mentioned in step 8. Upon reception of the Nsmf_PDUSession_CreateSMContext Request message, the SMF 71 may send the Npcf_SMPpolicy_Control_Create message including the information indicating that the URSP validity check completes successfully along with the information mentioned in step 9. Upon reception of the Npcf_SMPpolicy_Control_Create message, the PCF 73 may determine that the URSP validity check has been completed successfully base on the information indicating that the URSP validity check completes successfully and may skip the URSP validity check. Then the PCF 73 may perform the processes in step 11.

### Variant 2 of the First Example of the Second Aspect

In another implementation the UE 3's URSP rule(s) validity check, e.g. whether the application App_ID in the UE 3 requesting service on the S-NSSAI and the DNN is entitled for that service, may be performed in the AMF 70 instead in the PCF 73 as per the description FIG. 5. In this case, after step 7 in FIG. 5 the AMF 70 may make use of the UE Policy association procedure of the AMF 70 with the PCF 73 as defined in Section 4.16.11 in NPL 5, to request from the PCF 73 the latest copy of the URSP rule(s) related to the UE 3. The AMF 70 sends an Npcf_UEPolicyControl_Create Request message to the PCF 73. Along with the parameters related to the policy association, the AMF 70 also includes the UE_ID and ‘URSP_required’ parameter in the Npcf_UEPolicyControl_Create Request message. The ‘URSP_required’ parameter may indicate that the AMF 70 requests the URSP rule(s) for the UE 3 identified by the UE_ID. Alternatively, the AMF 70 may make use of any other existing or a new service or message between the AMF 70 and the PCF 73 in order to retrieve the UE 3's URSP rule(s) from the PCF 73. If the PCF 73 received a request from the AMF 70 to provide the URSP rule(s) for the UE_ID (e.g. the URSP rule(s) for the UE identified by the UE_ID), the PCF 73 responds with an Npcf_UEPolicyControl_Create Response message. The PCF 73 includes the UE_ID and the latest copy of the URSP rule(s) for that UE_ID (e.g. the latest copy of the URSP rule(s) for the UE identified by the UE_ID). Then the AMF 70 performs the URSP validity check for the UE 3, i.e. the AMF 70 checks whether the UE 3 or an application on UE 3 is entitled for a service on the S-NSSAI and the DNN and optionally on PDU Session with PDU_Session_ID requested by the UE 3, e.g. whether the App_ID in the URSP copy from the PCF 73 is mapped with the S-NSSAI and the DNN and optionally the PDU_Session_ID. For example, the AMF 70 may perform the URSP validity check in the same manner as step 10 in FIG. 5. If the URSP validity check by the AMF 70 is successful, the AMF 70 continues with the PDU Session Establishment procedure. For example, in a case where the URSP validity check by the AMF 70 is successful, the AMF 70 may send the Nsmf_PDUSession_CreateSMContext Request message as per step 8 in FIG. 5. For example, in a case where the URSP validity check by the AMF 70 is successful, the AMF 70 may include information indicating that the URSP validity check completes successfully in the Nsmf_PDUSession_CreateSMContext Request message in step 8 of FIG. 5. In this case, the SMF 71 includes the information indicating that the URSP validity check completes successfully in the Npcf_SMPpolicy_Control_Create message in step 9 of FIG. 5. Upon reception of the Npcf_SMPpolicy_Control_Create message, the PCF 73 may skip the URSP validity check in step 10 of FIG. 5 or may perform the URSP validity check. Then the PCF 73 may perform the processes in step 11. If the URSP check by the AMF 70 is not successful, i.e. the URSP validity check fails, the AMF 70 rejects the PDU Session Establishment Request from the UE as per step 17 in FIG. 5.

### Variant 3 of the First Example of the Second Aspect

The reject cause which is set to ‘URSP rules not followed’ in steps 15, 16 and 17 may have an associated information for reason of rejection. The UE 3 takes an appropriate action based on the associated information. The associated information may be one or combination of followings.
Requested Application ID (e.g. App-ID or App_ID) is not allowed to establish PDU session with designated S-NSSAI.
Requested Application ID is not allowed to establish PDU session with designated DNN.
Requested Application ID is not allowed to establish PDU session with designated S-NSSAI and DNN.
Requested Application ID is not allowed to route the traffic on the already established PDU Session with PDU_Session_ID.
Requested Application ID is not allowed to establish PDU session with designated SSC mode.
Requested Application ID is not allowed to establish PDU session with designated access type. Access type can be 3GPP access, non-3PP access or Multi-Access.
Requested Application ID is not allowed to establish PDU session with current UE location. I.E. Location Criteria in the Route Selection Validation Criteria in the Route Selection Descriptor does not match.
Requested Application ID is not allowed to establish PDU session with requested time. I.E. Time Window in the Route Selection Validation Criteria in the Route Selection Descriptor does not match.

### Variant 4 of the First Example of the Second Aspect

At step 10 in FIG. 5, if URSP validity check fails, i.e. PCF 73 may decide that the UE 3 does not have the latest version of the UE Policy, e.g. the latest version of the URSP rules, and the PCF may initiate UE Policy update in the UE 3 as per section 4.2.4.3 in NPL 5.

### Second Example of the Second Aspect

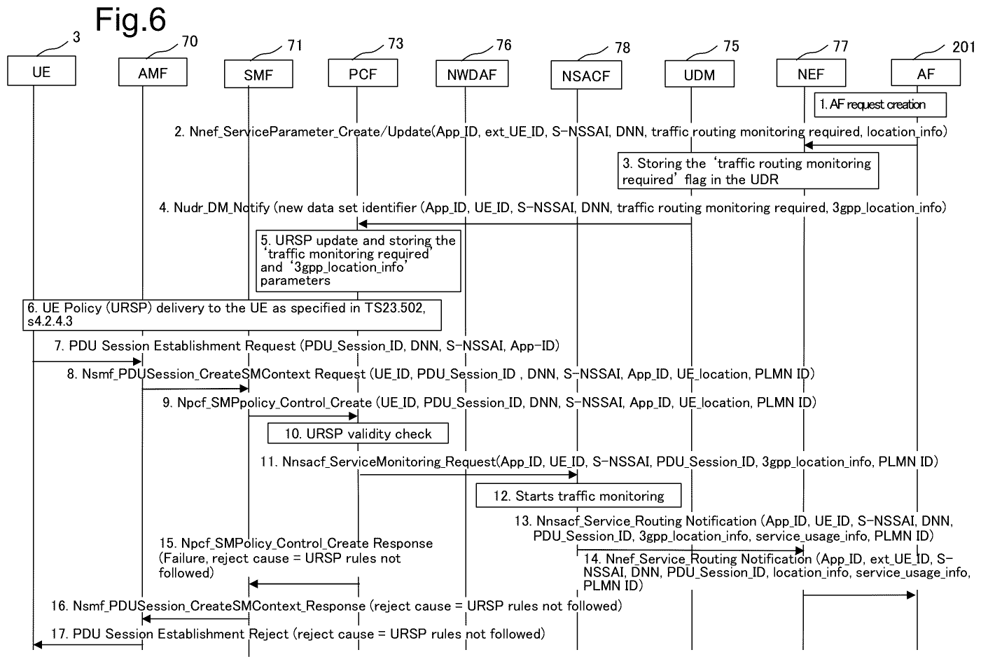

The Second example of the Second Aspect in FIG. 6 proposes a solution for access control and monitoring for the services provided on the S-NSSAI and DNN by external service providers where the access control is performed by a PCF 73 and the monitoring is performed by an NSACF 78.

The detailed processes of the Second example of the Second Aspect are as described below.

Step 1. AF request creation—An AF 201 can provide service specific parameters to the 5G system via the NEF 77 as specified in section 4.15.6.7 in NPL 5. The AF 201 may issue requests on behalf of an outside application owned or not owned by the PLMN serving the UE 3.

Step 2. The AF 201 sends an Nnef_ServiceParameter_Create/Update message to the NEF 77. The Nnef_ServiceParameter_Create/Update message includes App_ID, ext_UE_ID, S-NSSAI, DNN, and traffic routing monitoring required. The Nnef_ServiceParameter_Create/Update message may include location_info. The location_info may be expressed as location information. The App_ID may identify the service provider, i.e. the AF 201. The ext_UE_ID may be in the form of GPSI or external Group Identity. The AF 201 includes, in the message, the S-NSSAI and a DNN to identify the service provided by the AF 201. The AF 201 may also include in the message to the NEF 77 a ‘traffic routing monitoring required’ parameter or any other notation for a parameter which identifies a request by the AF 201 to the 3GPP system for monitoring and control the access to services provided by the combination of the S-NSSAI and the DNN, e.g. whether at least one of a UE 3 and the application in a UE 3 which requests a service on at least one of the S-NSSAI and the DNN are entitled to this service by the URSP rule(s) for that UE 3.

If the ‘traffic routing monitoring required’ parameter is included by the AF 201, the 3GPP system monitors and controls the use of the service provided by at least one of the S-NSSAI and the DNN. For example, the 3GPP system may reject services from applications and UE(s) that is not entitled for the service based on the latest URSP rule(s) provided to the UE by the 3GPP system. If a location_info parameter is included by the AF 201, the use of the service e.g. PDU Sessions on the S-NSSAI and the DNN may be monitored and controlled by the network only in the location(s) identified by the location_info parameter represented in geographical or any other manner.

Step 3. The NEF 77 stores the AF 201 requested information in the UDM 75 in the Application data section and the NEF 77 also does some mapping like ext_UE_ID to 3GPP UE identity (for example GPSI to SUPI): Service Identity to S-NSSAI and DNN if the AF 201 has provided the service identity instead the S-NSSAI and the DNN. If the location_info is provided by the AF 201, the NEF 77 maps the provided location_info to 3GPP compatible location information e.g. 3gpp_location_info defined as one or more cells or one or more TAs. The NEF 77 also stores in the UDM 75 the ‘traffic routing monitoring required’ parameter. The NEF 77 may store the 3GPP compatible location information from the ‘3gpp_location_info’ parameter related to the UE_ID (e.g. SUPI), if provided by the AF 201. Alternatively, the ‘traffic routing monitoring required’ parameter and the ‘3gpp_location_info’ parameter may be stored in the UDM 75 by the network operator based on the SLA agreements with the external service providers, i.e. AF 201. The NEF 77 may store the above information in the UDR.

Step 4. The UDM 75 sends an Nudr_DM_Notify message to the PCF 73 as per Session 5.2.12.2. 1-1 in NPL 5. The Nudr_DM_Notify message may include the App_ID, the UE_ID, the S-NSSAI, the DNN, the traffic routing monitoring required, and the 3gpp_location_info. For example, if the UE 3 is registered to the network and a PCF 73 is subscribed for notifications by the UDM 75 when the application data for the UE 3 is modified, the UDM 75 may send the Nudr_DM_Notify message to the PCF 73. For example, if the information mentioned in the step 3 is stored in the UDM 75, e.g. in the UDR of the UDM 75. The UDR of the UDM 75 may send the Nudr_DM_Notify message to the PCF 73.

Step 5. The PCF 73 updates the UE Policy (i.e. the URSP rule(s)) for the UE 3 indicated by the Nudr_DM_Notify message from the UDM 75 and the PCF 73 stores the traffic monitoring required parameter and the 3gpp_location_info parameter within the PCC rules in the PCF 73 for the UE 3. The PCF 73 may associate and store the App_ID, the UE_ID, the S-NSSAI, the DNN the traffic monitoring required parameter and the 3gpp_location_info parameter.

Step 6. The PCF 73 provides the updated UE Policy with the updated URSP rule(s) to the UE 3 via the UE Policy update procedure as per Section 4.2.4.3 in NPL 5.

Step 7. At some stage an application with App_ID in the UE 3 requests a service on at least one of S-NSSAI and DNN. In this case, the UE 3 sends a PDU Session Establishment Request message to an AMF 70. The UE 3 includes PDU_Session_ID, the DNN and the S-NSSAI in the PDU Session Establishment Request message. The UE 3 also includes a service application identity (i.e. App_ID) in the PDU Session Establishment Request message to the AMF 70. The App_ID may be Application identifier or OS identifier or a combination of the Application identifier and the OS identifier.

Step 8. The AMF 70 selects an SMF 71 as per the requirements in NPL 5 and sends an Nsmf_PDUSession_CreateSMContext Request message to the SMF 71. The AMF 70 includes, in the Nsmf_PDUSession_CreateSMContext Request message, the UE_ID and the PDU Session_ID, the DNN and the S-NSSAI parameters received from the UE 3. The AMF 70 also includes the application identity (i.e. App_ID), UE location and PLMN ID in the Nsmf_PDUSession_CreateSMContext Request message to the SMF 71.

The AMF 70 may include, in the Nsmf_PDUSession_CreateSMContext Request message, PLMN ID, either the PLMN name or PLMN Identification comprising MCC and MNC of the PLMN that the AMF 70 belongs to.

The UE location may indicate location information of the UE 3, for example TAI where the UE 3 locates. The UE location may not be included in the Nsmf_PDUSession_CreateSMContext Request message. The UE_ID may be an identifier of the UE 3.

Step 9. The SMF 71 triggers policy association with the PCF 73 and sends an Npcf_SMPpolicy_Control_Create message to the PCF 73. The SMF 71 includes, in the Npcf_SMPpolicy_Control_Create message, as parameters the UE_ID, the PDU_Session_ID, the DNN, the S-NSSAI and the PLMN ID received from the AMF 70. The SMF 71 also includes the App_ID and the UE_location information in the Npcf_SMPpolicy_Control_Create message to the PCF 73. If the UE_location information was provided to the SMF 71, the SMF 71 may include the UE_location information in the Npcf_SMPpolicy_Control_Create message.

Step 10. URSP validity check-If the PCF 73 does not have the subscriber's subscription related information, the PCF 73 sends a request to the UDM 75 by invoking Nudr_DM_Query service in order to receive the information related to the PDU Session_ID. The Nudr_DM_Query service or Nudr_DM_Query message may include SUPI (e.g. SUPI of the UE 3), the DNN, and the S-NSSAI. The PCF 73 may request notifications from the UDM 75 on changes in the subscription information by invoking Nudr_DM_Subscribe message as per Session 4.16.9 in NPL 5. The PCF 73 checks UE's URSP validity, i.e. whether the UE 3 or an application in the UE 3 is entitled for a service on the requested S-NSSAI and DNN. For example, the PCF 73 may check whether the application identity (i.e. the App_ID) in the UE 3 is allowed to be mapped with the S-NSSAI and DNN provided in the Npcf_SMPpolicy_Control_Create message from the SMF 71. The PCF 73 checks the PDU Session routing rules for the UE 3 from the latest URSP rule(s) for that UE 3 which are stored in the PCF 73. To pass the URSP validity check, the App_ID mapping to the S-NSSAI and the DNN and optionally a PDU_Session_ID within the URSP rule(s) copy for UE 3 stored within the PCF 73 needs to match with the App_ID, the S-NSSAI and the DNN and optionally the PDU_Session_ID parameters provided from the AMF 70, i.e. the UE 3's URSP rules copy provided by the UE 3 and the UE 3's URSP rules copy stored in the PCF 73 need to match. If 3gpp_location_info is provided to the PCF 73, the PCF 73 checks whether the UE 3's location is within the location provided via the 3gpp_location_info. If the UE 3's location is outside of the location provided via the 3gpp_location_info, the UE 3 is not entitled for a service on the S-NSSAI and the DNN even if the App_ID requesting the service is mapped with the S-NSSAI and DNN (e.g. even if the URSP validity check passes). For example, the PCF 73 determines that the UE's URSP validity check passes (e.g. the PCF 73 determines that the UE 3's URSP rule(s) provided by the UE 3 matches with the UE 3's URSP rule(s) stored in the PCF 73 or the PCF 73 determines that combination of the App_ID, the S-NSSAI and the DNN and optionally the PDU_Session_ID stored in the PCF 73 in step 5 matches with combination of the App_ID, the S-NSSAI and the DNN and optionally the PDU_Session_ID received from the AMF 70 via the SMF 71), the PCF 73 determines that the App_ID in the UE 3 is entitled for a service on the requested S-NSSAI and the DNN. If 3gpp_location_info is not provided to the PCF 73, the PCF 73 may skip checking whether the UE 3's location is within the location provided via the 3gpp_location_info.

Step 11. If the App_ID in the UE 3 and the UE 3 itself is entitled for a service on the requested S-NSSAI and the DNN as a result of the URSP validity check by the PCF 73 (e.g. the PCF 73 determines that the App_ID in the UE 3 is entitled for a service on the requested S-NSSAI and the DNN and optionally PDU_Session_ID), the PCF 73 sends an Nnsacf_ServiceMonitoring_Request message to the NSACF 78. The PCF 73 includes the App_ID, the UE_ID, the S-NSSAI, the DNN, the 3gpp_location_info, the PLMN ID and optionally PDU Session ID in the Nnsacf_ServiceMonitoring_Request message to the NSACF 78. Alternatively, the PCF 73 may make use of any other existing or new message between the PCF 73 and the NSACF 78 to convey the App_ID, the UE_ID, the S-NSSAI, the DNN and the 3gpp_location_info for the purpose of service usage monitoring on the S-NSSAI and the DNN and optionally the PDU_Session_ID. If the 3gpp_location_info is provided to the PCF 73, the PCF 73 may include the 3gpp_location_info in the Nnsacf_ServiceMonitoring_Request message.

Step 12. The NSACF 78 starts monitoring the traffic routing on the S-NSSAI and the DNN by the App_ID in the UE 3 and optionally the PDU session with PDU_Session_ID, if provided. For example, the NSACF 78 starts monitoring the traffic routing on the S-NSSAI and the DNN and optionally PDU_Session_ID that correspond to the App_ID provided by the PCF 73. If 3gpp_location_info is included by the PCF 73, the monitoring applies for the location defined in the 3gpp_location_info parameter. The location information may be defined in terms of one or more cells or one or more TAs. If the 3gpp_location_info parameter is provided by the PCF 73, the NSACF 78 may subscribe for the UE 3's location tracking by the AMFs so that the NSACF 78 can monitor for the service access to the S-NSSAI and the DNN by the UE 3 only when the UE 3 is within the location defined by the 3gpp_location_info parameter.

Step 13. If the AF 201 is subscribed for traffic routing notifications with the NSACF 78, the NSACF 78 may trigger notifications to the NEF 77 each time a service on the S-NSSAI and the DNN is accessed. The NSACF 78 sends an Nnsacf_Service_Routing Notification message to the NEF 77. The NSACF 78 includes, in the Nnsacf_Service_Routing Notification message, the App_ID, the UE_ID, the S-NSSAI, the DNN, the PDU_Session_ID, the 3gpp_location_info if applicable, the PLMN ID and the service_usage_info which may include information about duration of the service access on the S-NSSAI and the DNN.

Alternatively, the NSACF 78 may make use of any other existing or new notification service or message between the NSACF 78 and the NEF 77 to convey the App_ID, the UE_ID, the S-NSSAI, the DNN, the PDU_Session_ID, the 3gpp_location_info, the PLMN ID and the service_usage_info to the NEF 77. If the 3gpp_location_info is provided to the NSACF 78, the NSACF 78 may include the 3gpp_location_info in the Nnsacf_Service_Routing Notification message. For example, the NSACF 78 may send the Nnsacf_Service_Routing Notification message in a case where the NSACF 78 detects the traffic routing on the S-NSSAI and the DNN and optionally on the PDU session with PDU_Session_ID that correspond to the App_ID. For example, the NSACF 78 may send the Nnsacf_Service_Routing Notification message in a case where the AF 201 is subscribed for traffic routing notifications with the NSACF 78 and the NSACF 78 detects the traffic routing on the S-NSSAI and the DNN and PDU session with PDU_Session_ID that correspond to the App_ID.

Step 14. The NEF 77 maps the UE_ID to ext_UE_ID, 3gpp_location_info to a geographical location_info and sends an Nnef_Service_Routing Notification message to the AF 201. The Nnef_Service_Routing Notification message may include the App_ID, the ext_UE_ID, the S-NSSAI, the DNN, the location_info (e.g. the geographical location_info), the service_usage_info, and the PLMN ID. Alternatively, the NEF 77 may make use of any other existing or new notification service or message between the NEF 77 and the AF 201 to convey the App_ID, the ext_UE_ID, the S-NSSAI, the DNN, the PDU_Session_ID, the location_info and the service_usage_info to the AF 201

Step 15. If at step 10 the URSP validity check fails, i.e. the PCF 73 decides that the application in the UE 3 that has requested service on the S-NSSAI and on the DNN is not entitled for service on that S-NSSAI and the DNN (e.g. the PCF 73 determines that the UE 3's URSP rule(s) provided by the UE 3 does not match with the UE 3's URSP rule(s) stored in the PCF 73 or the PCF 73 determines that the combination of the App_ID, the S-NSSAI and the DNN and optionally the PDU_Session_ID stored in the PCF 73 in step 5 does not match with combination of the App_ID, the S-NSSAI and the DNN and optionally the PDU_Session_ID received from the AMF 70 via the SMF 71), the PCF 73 returns an Npcf_SMPolicy_Control_Create Response message to the SMF 71. The PCF 73 includes, in the Npcf_SMPolicy_Control_Create Response message, a Failure result parameter and a reject cause. The reject cause may be set to ‘URSP rules not followed’ or any other notation for a reject cause which indicates that the UE 3 or an application on the UE 3 is not entitled for a service on the requested S-NSSAI and the DNN, e.g. the URSP rule(s) for the UE 3 do not allow mapping for the App_ID to the S-NSSAI and the DNN. The reason for the service mapping mismatch could be either the UE 3 does not have the latest URSP rule(s), i.e. URSP rule(s) mismatch between the URSP copies in the UE 3 and in the PCF 73 or the UE 3 does not follow the URSP rule(s).

Step 16. If the SMF 71 receives the Npcf_SMPolicy_Control_Create Response message from the PCF 73 with a Failure result and with the reject cause which is set to ‘URSP rules not followed’, the SMF 71 responds with an Nsmf_PDUSession_CreateSMContext_Response message to the AMF 70. The SMF 71 includes, in the Nsmf_PDUSession_CreateSMContext_Response message, the reject cause transmitted by the PCF 73.

Step 17. Upon reception of the Nsmf_PDUSession_CreateSMContext_Response message, the AMF 70 rejects the PDU Session establishment Request from the UE 3 by sending a PDU Session Establishment Reject message. The AMF 70 includes in the PDU Session Establishment Reject message a reject cause which is set to ‘URSP rules not followed’ or any other notation for a reject cause which indicates that the UE 3 or an application on the UE 3 is not entitled for a service on the requested S-NSSAI and the DNN, e.g. the URSP rule(s) for the UE 3 do not allow mapping for the App_ID to the S-NSSAI and the DNN.

When the UE 3 receives PDU Session Establishment Reject message with the reject cause which is set to ‘URSP rules not followed’, the UE 3 does not attempt another request for PDU Session establishment on the S-NSSAI and the DNN for which it was rejected until the UE 3 receives an update to the URSP rule(s) from the network. If the UE 3 continues being rejected multiple times (this number of times may be a 3GPP standardised value or it could be configured by configurations in the UE 3) with the same reject cause which is set to ‘URSP rules not followed’, the UE 3 does not attempt another PDU Session establishment request on the S-NSSAI and the DNN until the UE 3 re-registers.

According to the above, for example, the 5G network and the third-party Service Provider (e.g. the AF 201) can know when an application of a third-party Service Provider is routed using provisioned URSP rule(s).

### Variant 1 of the Second Example of the Second Aspect

The Variants 1-3 of the First example of the Second Aspect can apply to the Second example of the Second Aspect as the Variant 1.

### <System Overview>

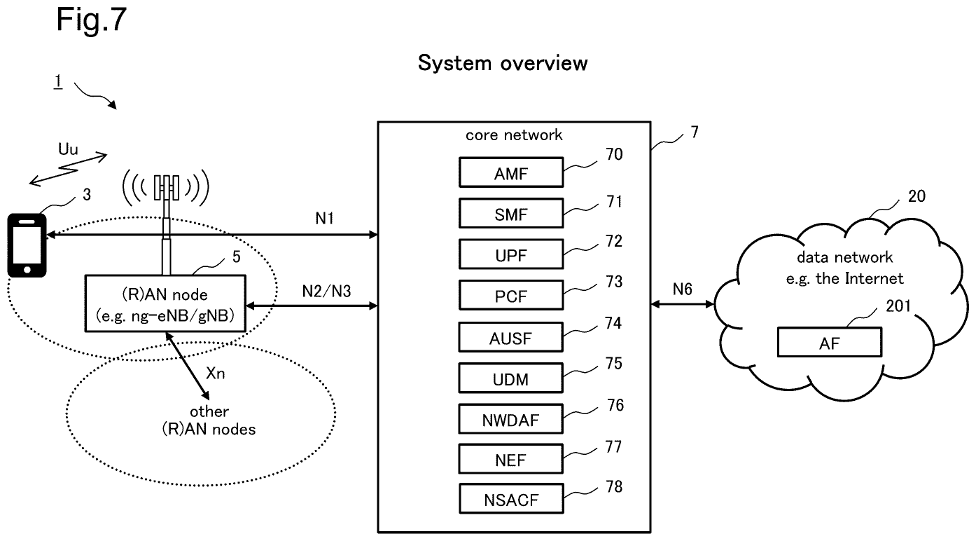

FIG. 7 schematically illustrates a telecommunication system 1 for a mobile (cellular or wireless) to which the above aspects are applicable.

The telecommunication system 1 represents a system overview in which an end to end communication is possible. For example, UE 3 (or user equipment, ‘mobile device’ 3) communicates with other UEs 3 or service servers in the data network 20 via respective (R)AN nodes 5 and a core network 7.

The (R)AN node 5 supports any radio accesses including a 5G radio access technology (RAT), an E-UTRA radio access technology, a beyond 5G RAT, a 6G RAT and non-3GPP RAT including wireless local area network (WLAN) technology as defined by the Institute of Electrical and Electronics Engineers (IEEE).

The (R)AN node 5 may split into a Radio Unit (RU), Distributed Unit (DU) and Centralized Unit (CU). In some aspects, each of the units may be connected to each other and structure the (R)AN node 5 by adopting an architecture as defined by the Open RAN (O-RAN) Alliance, where the units above are referred to as O-RU, O-DU and O-CU respectively.

The (R)AN node 5 may be split into control plane function and user plane function. Further, multiple user plane functions can be allocated to support a communication. In some aspects, user traffic may be distributed to multiple user plane functions and user traffic over each user plane functions are aggregated in both the UE 3 and the (R)AN node 5. This split architecture may be called as ‘dual connectivity’ or ‘Multi connectivity’.

The (R)AN node 5 can also support a communication using the satellite access. In some aspects, the (R)AN node 5 may support a satellite access and a terrestrial access.

In addition, the (R)AN node 5 can also be referred as an access node for a non-wireless access. The non-wireless access includes a fixed line access as defined by the Broadband Forum (BBF) and an optical access as defined by the Innovative Optical and Wireless Network (IOWN).

The core network 7 may include logical nodes (or ‘functions’) for supporting a communication in the telecommunication system 1. For example, the core network 7 may be 5G Core Network (5GC) that includes, amongst other functions, control plane functions and user plane functions. Each function in logical nodes can be considered as a network function. The network function may be provided to another node by adapting the Service Based Architecture (SBA).

A Network Function can be deployed as distributed, redundant, stateless, and scalable that provides the services from several locations and several execution instances in each location by adapting the network virtualization technology as defined by the European Telecommunications Standards Institute, Network Functions Virtualization (ETSI NFV).

The core network 7 may support the Non-Public Network (NPN). The NPN may be a Stand-alone Non-Public Network (SNPN) or a Public Network Integrated NPN (PNI-NPN).

As is well known, a UE 3 may enter and leave the areas (i.e. radio cells) served by the (R)AN node 5 as the UE 3 is moving around in the geographical area covered by the telecommunication system 1. In order to keep track of the UE 3 and to facilitate movement between the different (R)AN nodes 5, the core network 7 comprises at least one access and mobility management function (AMF) 70. The AMF 70 is in communication with the (R)AN node 5 coupled to the core network 7. In some core networks, a mobility management entity (MME) or a mobility management node for beyond 5G or a mobility management node for 6G may be used instead of the AMF 70.

The core network 7 also includes, amongst others, a Session Management Function (SMF) 71, a User Plane Function (UPF) 72, a Policy Control Function (PCF) 73, an Authentication Server Function (AUSF) 74, a Unified Data Management (UDM) 75, and a Network Data Analytics Function (NWDAF) 76, a Network Exposure Function (NEF) 77, and Network Slice Admission Control Function (NSACF) 78. When the UE 3 is roaming to a visited Public Land Mobile Network (VPLMN), a home Public Land Mobile Network (HPLMN) of the UE 3 provides the UDM 75 and at least some of the functionalities of the SMF 71, UPF 72, and PCF 73 for the roaming-out UE 3.

The UE 3 and a respective serving (R)AN node 5 are connected via an appropriate air interface (for example the so-called “Uu” interface and/or the like). Neighboring (R)AN node 5 are connected to each other via an appropriate (R)AN node 5 to (R)AN node interface (such as the so-called “Xn” interface and/or the like). Each (R)AN node 5 is also connected to nodes in the core network 7 (such as the so-called core network nodes) via an appropriate interface (such as the so-called “N2”/“N3” interface(s) and/or the like). From the core network 7, connection to a data network 20 is also provided. The data network 20 can be an internet, a public network, an external network, a private network or an internal network of the PLMN. In case that the data network 20 is provided by a PLMN operator or Mobile Virtual Network Operator (MVNO), the IP Multimedia Subsystem (IMS) service may be provided by that data network 20. The UE 3 can be connected to the data network 20 using IPv4, IPV6, IPv4v6, Ethernet or unstructured data type. One example, an AF 201 can be a network element in the data network 20 where the UE 3 communicates with (see FIG. 7). Another example, an AF 201 can be a network element in the core network 7.

The “Uu” interface may include a Control plane of Uu interface and User plane of Uu interface.

The User plane of Uu interface is responsible to convey user traffic between the UE 3 and a serving (R)AN node 5. The User plane of Uu interface may have a layered structure with SDAP, PDCP, RLC and MAC sublayer over the physical connection.

The Control plane of Uu interface is responsible to establish, modify and release a connection between the UE 3 and a serving (R)AN node 5. The Control plane of Uu interface may have a layered structure with RRC, PDCP, RLC and MAC sublayers over the physical connection.

For example, the following messages are communicated over the RRC layer to support AS signaling.
RRC Setup Request message: This message is sent from the UE 3 to the (R)AN node 5. In addition to the parameters that are disclosed by Aspects in this disclosure, following parameters may be included together in the RRC Setup Request message.
   establishmentCause and ue-Identity. The ue-Identity may have a value of ng-5G-S-TMSI-Part1 or random Value.
RRC Setup message: This message is sent from the (R)AN node 5 to the UE 3. In addition to the parameters that are disclosed by Aspects in this disclosure, following parameters may be included together in the RRC Setup message.
   masterCellGroup and radioBearerConfig
RRC setup complete message: This message is sent from the UE 3 to the (R)AN node 5. In addition to the parameters that are disclosed by Aspects in this disclosure, following parameters may be included together in the RRC setup complete message.
   guami-Type, iab-NodeIndication, idleMeasAvailable, mobility State, ng-5G-S-TMSI-Part2, registeredAMF, selectedPLMN-Identity

The UE 3 and the AMF 70 are connected via an appropriate interface (for example the so-called N1 interface and/or the like). The N1 interface is responsible to provide a communication between the UE 3 and the AMF 70 to support NAS signaling. The N1 interface may be established over a 3GPP access and over a non-3GPP access. For example, the following messages are communicated over the N1 interface.
registration request message: This message is sent from the UE 3 to the AMF 70. In addition to the parameters that are disclosed by Aspects in this disclosure, following parameters may be included together in the registration request message.
   5GS registration type, ngKS1, 5GS mobile identity, Non-current native NAS key set identifier, 5GMM capability, UE security capability, Requested NSSAI, Last visited registered TAI, SI UE network capability, Uplink data status, PDU session status, MICO indication, UE status, Additional GUTI, Allowed PDU session status, UE's usage setting, Requested DRX parameters, EPS NAS message container, LADN indication, Payload container type, Payload container, Network slicing indication, 5GS update type, Mobile station classmark 2, Supported codecs, NAS message container, EPS bearer context status, Requested extended DRX parameters, T3324 value, UE radio capability ID, Requested mapped NSSAI, Additional information requested, Requested WUS assistance information, N5GC indication and Requested NB-N1 mode DRX parameters.
registration accept message: This message is sent from the AMF 70 to the UE 3. In addition to the parameters that are disclosed by Aspects in this disclosure, following parameters may be included together in the registration accept message. 5GS registration result, 5G-GUTI, Equivalent PLMNs, TAI list, Allowed NSSAI, Rejected NSSAI, Configured NSSAI, 5GS network feature support, PDU session status, PDU session reactivation result, PDU session reactivation result error cause, LADN information, MICO indication, Network slicing indication, Service area list, T3512 value, Non-3GPP de-registration timer value, T3502 value, Emergency number list, Extended emergency number list, SOR transparent container, EAP message, NSSAI inclusion mode, Operator-defined access category definitions, Negotiated DRX parameters, Non-3GPP NW policies, EPS bearer context status, Negotiated extended DRX parameters, T3447 value, T3448 value, T3324 value, UE radio capability ID, UE radio capability ID deletion indication, Pending NSSAI, Ciphering key data, CAG information list, Truncated 5G-S-TMSI configuration, Negotiated WUS assistance information, Negotiated NB-N1 mode DRX parameters and Extended rejected NSSAI.
Registration Complete message: This message is sent from the UE 3 to the AMF 70. In addition to the parameters that are disclosed by Aspects in this disclosure, following parameters may be included together in the Registration Complete message.
   SOR transparent container.
Authentication Request message: This message is sent from the AMF 70 to the UE 3. In addition to the parameters that are disclosed by Aspects in this disclosure, following parameters may be included together in the Authentication Request message.
   ngKS1, ABBA, Authentication parameter RAND (5G authentication challenge), Authentication parameter AUTN (5G authentication challenge) and EAP message.
Authentication Response message: This message is sent from the UE 3 to the AMF 70. In addition to the parameters that are disclosed by Aspects in this disclosure, following parameters may be populated together in the Authentication Response message.
   Authentication response message identity, Authentication response parameter and EAP message.
Authentication Result message: This message is sent from the AMF 70 to the UE 3. In addition to the parameters that are disclosed by Aspects in this disclosure, following parameters may be populated together in the Authentication Result message.
   ngKS1, EAP message and ABBA.
Authentication Failure message: This message is sent from the UE 3 to the AMF 70. In addition to the parameters that are disclosed by Aspects in this disclosure, following parameters may be populated together in the Authentication Failure message.
   Authentication failure message identity, 5GMM cause and Authentication failure parameter.
Authentication Reject message: This message is sent from the AMF 70 to the UE 3. In addition to the parameters that are disclosed by Aspects in this disclosure, following parameters may be populated together in the Authentication Reject message.
   EAP message.
Service Request message: This message is sent from the UE 3 to the AMF 70. In addition to the parameters that are disclosed by Aspects in this disclosure, following parameters may be populated together in the Service Request message.
   ngKS1, Service type, 5G-S-TMSI, Uplink data status, PDU session status, Allowed PDU session status, NAS message container.
Service Accept message: This message is sent from the AMF 70 to the UE 3. In addition to the parameters that are disclosed by Aspects in this disclosure, following parameters may be populated together in the Service Accept message.
   PDU session status, PDU session reactivation result, PDU session reactivation result error cause, EAP message and T3448 value.
Service Reject message: This message is sent from the AMF 70 to the UE 3. In addition to the parameters that are disclosed by Aspects in this disclosure, following parameters may be populated together in the Service Reject message.
   5GMM cause, PDU session status, T3346 value, EAP message, T3448 value and CAG information list.
Configuration Update Command message: This message is sent from the AMF 70 to the UE 3. In addition to the parameters that are disclosed by Aspects in this disclosure, following parameters may be populated together in the Configuration Update Command message.
   Configuration update indication, 5G-GUTI, TAI list, Allowed NSSAI, Service area list, Full name for network, Short name for network, Local time zone, Universal time and local time zone, Network daylight saving time, LADN information, MICO indication, Network slicing indication, Configured NSSAI, Rejected NSSAI, Operator-defined access category definitions, SMS indication, T3447 value, CAG information list, UE radio capability ID, UE radio capability ID deletion indication, 5GS registration result, Truncated 5G-S-TMSI configuration, Additional configuration indication and Extended rejected NSSAI.
Configuration Update Complete message: This message is sent from the UE 3 to the AMF 70. In addition to the parameters that are disclosed by Aspects in this disclosure, following parameters may be populated together in the Configuration Update Complete message.
   Configuration update complete message identity.

### <User Equipment (UE)>

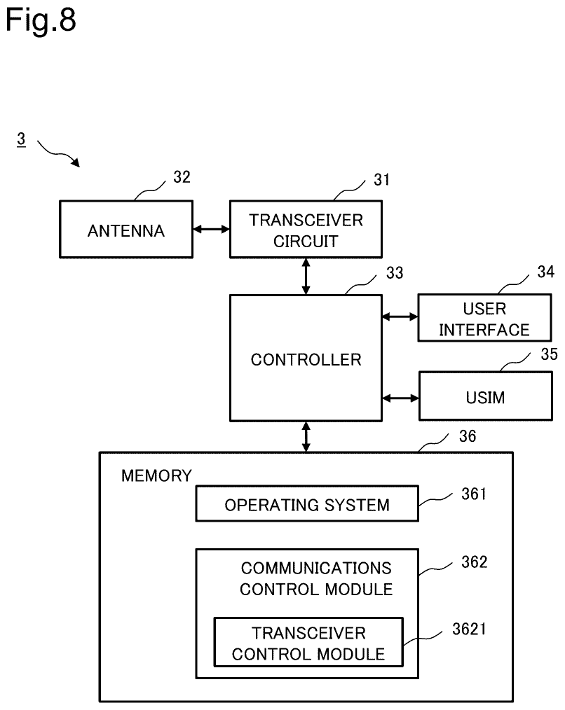

FIG. 8 is a block diagram illustrating the main components of the UE 3 (mobile device 3). As shown, the UE 3 includes a transceiver circuit 31 which is operable to transmit signals to and to receive signals from the connected node(s) via one or more antennas 32. Further, the UE 3 may include a user interface 34 for inputting information from outside or outputting information to outside. Although not necessarily shown in the Figure, the UE 3 may have all the usual functionality of a conventional mobile device and this may be provided by any one or any combination of hardware, software and firmware, as appropriate. Software may be pre-installed in the memory and/or may be downloaded via the telecommunication network or from a removable data storage device (RMD), for example. A controller 33 controls the operation of the UE 3 in accordance with software stored in a memory 36. The software includes, among other things, an operating system 361 and a communications control module 362 having at least a transceiver control module 3621. The communications control module 362 (using its transceiver control module 3621) is responsible for handling (generating/sending/receiving) signalling and uplink/downlink data packets between the UE 3 and other nodes, such as the (R)AN node 5 and the AMF 70. Such signalling may include, for example, appropriately formatted signalling messages (e.g. a registration request message and associated response messages) relating to access and mobility management procedures (for the UE 3). The controller 33 interworks with one or more Universal Subscriber Identity Module (USIM) 35. If there are multiple USIMs 35 equipped, the controller 33 may activate only one USIM 35 or may activate multiple USIMs 35 at the same time.

The UE 3 may, for example, support the Non-Public Network (NPN), The NPN may be a Stand-alone Non-Public Network (SNPN) or a Public Network Integrated NPN (PNI-NPN).

The UE 3 may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

The UE 3 may, for example, be an item of transport equipment (for example transport equipment such as: rolling stocks; motor vehicles; motor cycles; bicycles; trains; buses; carts; rickshaws; ships and other watercraft; aircraft; rockets; satellites; drones; balloons etc.).

The UE 3 may, for example, be an item of information and communication equipment (for example information and communication equipment such as: electronic computer and related equipment; communication and related equipment; electronic components etc.).

The UE 3 may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

The UE 3 may, for example, be an electrical application system or equipment (for example an electrical application system or equipment such as: an x-ray system; a particle accelerator; radio isotope equipment; sonic equipment; electromagnetic application equipment; electronic power application equipment etc.).

The UE 3 may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

The UE 3 may, for example, be a wireless-equipped personal digital assistant or related equipment (such as a wireless card or module designed for attachment to or for insertion into another electronic device (for example a personal computer, electrical measuring machine)).

The UE 3 may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices or Narrow Band-IoT UE (NB-IoT UE). It will be appreciated that a UE 3 may support one or more IoT or MTC applications.

The UE 3 may be a smart phone or a wearable device (e.g. smart glasses, a smart watch, a smart ring, or a hearable device).

The UE 3 may be a car, or a connected car, or an autonomous car, or a vehicle device, or a motorcycle or V2X (Vehicle to Everything) communication module (e.g. Vehicle to Vehicle communication module, Vehicle to Infrastructure communication module, Vehicle to People communication module and Vehicle to Network communication module).

### <(R)AN Node>

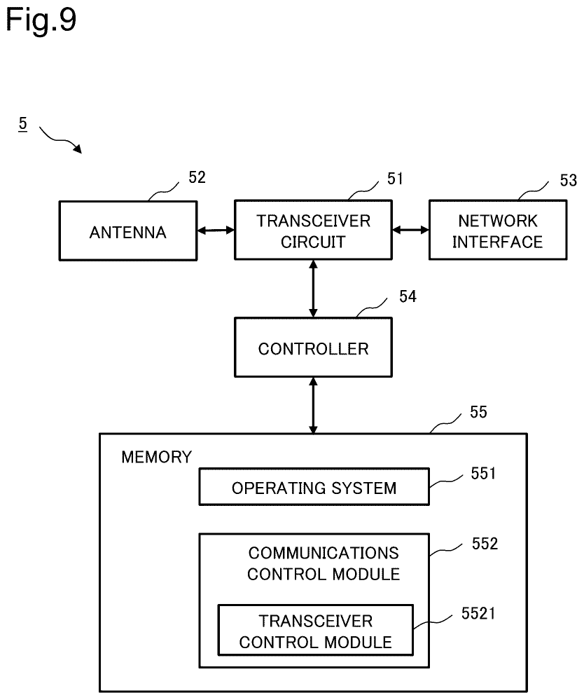

FIG. 9 is a block diagram illustrating the main components of an exemplary (R)AN node 5, for example a base station (‘eNB’ in LTE, ‘gNB’ in 5G, a base station for 5G beyond, a base station for 6G). As shown, the (R)AN node 5 includes a transceiver circuit 51 which is operable to transmit signals to and to receive signals from connected UE(s) 3 via one or more antennas 52 and to transmit signals to and to receive signals from other network nodes (either directly or indirectly) via a network interface 53. A controller 54 controls the operation of the (R)AN node 5 in accordance with software stored in a memory 55. Software may be pre-installed in the memory and/or may be downloaded via the telecommunication network or from a removable data storage device (RMD), for example. The software includes, among other things, an operating system 551 and a communications control module 552 having at least a transceiver control module 5521.

The communications control module 552 (using its transceiver control sub-module) is responsible for handling (generating/sending/receiving) signalling between the (R)AN node 5 and other nodes, such as the UE 3, another (R)AN node 5, the AMF 70 and the UPF 72 (e.g. directly or indirectly). The signalling may include, for example, appropriately formatted signalling messages relating to a radio connection and a connection with the core network 7 (for a particular UE 3), and in particular, relating to connection establishment and maintenance (e.g. RRC connection establishment and other RRC messages), NG Application Protocol (NGAP) messages (i.e. messages by N2 reference point) and Xn application protocol (XnAP) messages (i.e. messages by Xn reference point), etc. Such signalling may also include, for example, broadcast information (e.g. Master Information and System information) in a sending case.

The controller 54 is also configured (by software or hardware) to handle related tasks such as, when implemented, UE mobility estimate and/or moving trajectory estimation.

The (R)AN node 5 may support the Non-Public Network (NPN), The NPN may be a Stand-alone Non-Public Network (SNPN) or a Public Network Integrated NPN (PNI-NPN).

### <System Overview of (R)AN Node 5 Based on O-RAN Architecture>

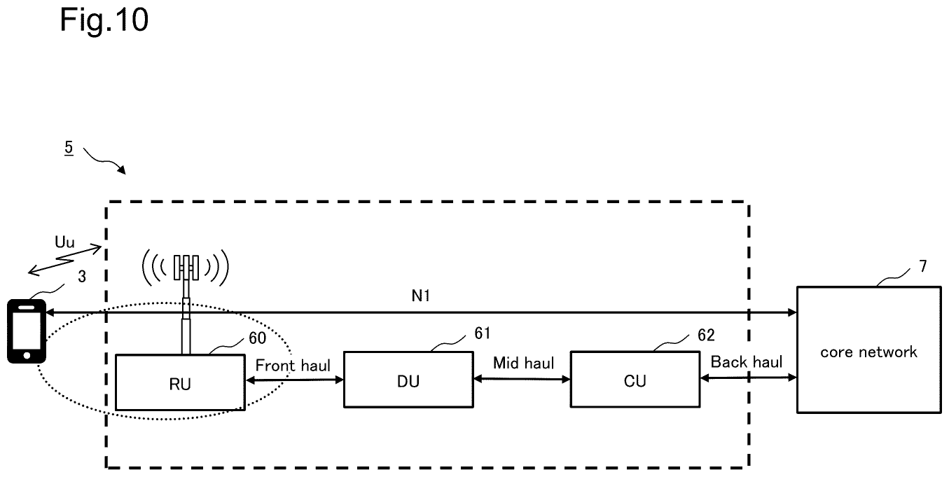

FIG. 10 schematically illustrates a (R)AN node 5 based on O-RAN architecture to which the (R)AN node 5 aspects are applicable.

The (R)AN node 5 based on O-RAN architecture represents a system overview in which the (R)AN node is split into a Radio Unit (RU) 60, Distributed Unit (DU) 61 and Centralized Unit (CU) 62. In some aspects, each unit may be combined. For example, the RU 60 can be integrated/combined with the DU 61 as an integrated/combined unit, the DU 61 can be integrated/combined with the CU 62 as another integrated/combined unit. Any functionality in the description for a unit (e.g. one of RU 60, DU 61 and CU 62) can be implemented in the integrated/combined unit above. Further, CU 62 can separate into two functional units such as CU Control plane (CP) and CU User plane (UP). The CU CP has a control plane functionality in the (R)AN node 5. The CU UP has a user plane functionality in the (R)AN node 5. Each CU CP is connected to the CU UP via an appropriate interface (such as the so-called “E1” interface and/or the like).

The UE 3 and a respective serving RU 60 are connected via an appropriate air interface (for example the so-called “Uu” interface and/or the like). Each RU 60 is connected to the DU 61 via an appropriate interface (such as the so-called “Front haul”, “Open Front haul”, “F1” interface and/or the like). Each DU 61 is connected to the CU 62 via an appropriate interface (such as the so-called “Mid haul”, “Open Mid haul”, “E2” interface and/or the like). Each CU 62 is also connected to nodes in the core network 7 (such as the so-called core network nodes) via an appropriate interface (such as the so-called “Back haul”, “Open Back haul”, “N2”/“N3” interface(s) and/or the like). In addition, a user plane part of the DU 61 can also be connected to the core network nodes 7 via an appropriate interface (such as the so-called “N3” interface(s) and/or the like).

Depending on functionality split among the RU 60, DU 61 and CU 62, each unit provides some of the functionality that is provided by the (R)AN node 5. For example, the RU 60 may provide functionalities to communicate with a UE 3 over air interface, the DU 61 may provide functionalities to support MAC layer and RLC layer, the CU 62 may provide functionalities to support PDCP layer, SDAP layer and RRC layer.

### <Radio Unit (RU)>

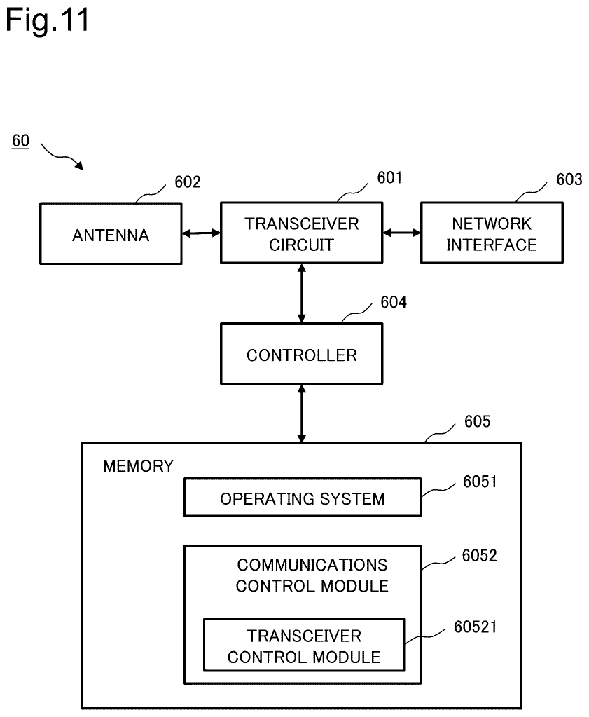

FIG. 11 is a block diagram illustrating the main components of an exemplary RU 60, for example a RU part of base station (‘eNB’ in LTE, ‘gNB’ in 5G, a base station for 5G beyond, a base station for 6G). As shown, the RU 60 includes a transceiver circuit 601 which is operable to transmit signals to and to receive signals from connected UE(s) 3 via one or more antennas 602 and to transmit signals to and to receive signals from other network nodes or network unit (either directly or indirectly) via a network interface 603. A controller 604 controls the operation of the RU 60 in accordance with software stored in a memory 605. Software may be pre-installed in the memory and/or may be downloaded via the telecommunication network or from a removable data storage device (RMD), for example. The software includes, among other things, an operating system 6051 and a communications control module 6052 having at least a transceiver control module 60521.

The communications control module 6052 (using its transceiver control sub-module) is responsible for handling (generating/sending/receiving) signalling between the RU 60 and other nodes or units, such as the UE 3, another RU 60 and DU 61 (e.g. directly or indirectly). The signalling may include, for example, appropriately formatted signalling messages relating to a radio connection and a connection with the RU 60 (for a particular UE 3), and in particular, relating to MAC layer and RLC layer.

The controller 604 is also configured (by software or hardware) to handle related tasks such as, when implemented, UE mobility estimate and/or moving trajectory estimation.

The RU 60 may support the Non-Public Network (NPN), The NPN may be a Stand-alone Non-Public Network (SNPN) or a Public Network Integrated NPN (PNI-NPN).

As described above, the RU 60 can be integrated/combined with the DU 61 as an integrated/combined unit. Any functionality in the description for the RU 60 can be implemented in the integrated/combined unit above.

### <Distributed Unit (DU)>

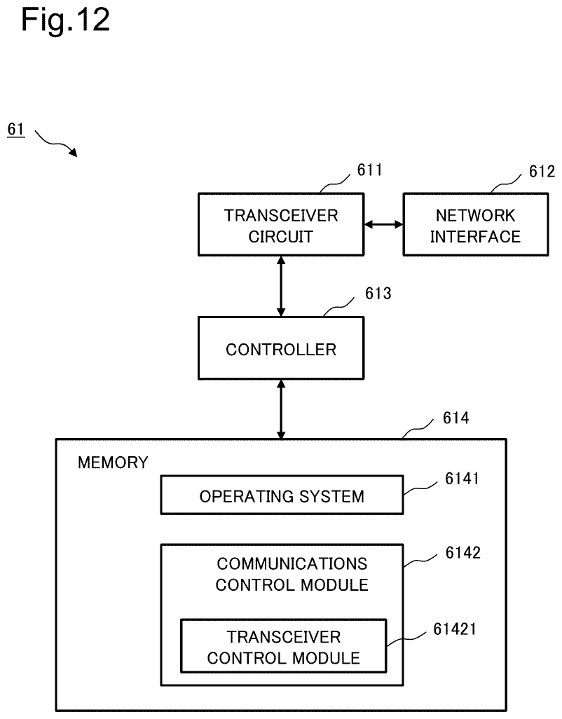

FIG. 12 is a block diagram illustrating the main components of an exemplary DU 61, for example a DU part of a base station (‘eNB’ in LTE, ‘gNB’ in 5G, a base station for 5G beyond, a base station for 6G). As shown, the apparatus includes a transceiver circuit 611 which is operable to transmit signals to and to receive signals from other nodes or units (including the RU 60) via a network interface 612. A controller 613 controls the operation of the DU 61 in accordance with software stored in a memory 614. Software may be pre-installed in the memory 614 and/or may be downloaded via the telecommunication network or from a removable data storage device (RMD), for example. The software includes, among other things, an operating system 6141 and a communications control module 6142 having at least a transceiver control module 61421. The communications control module 6142 (using its transceiver control module 61421 is responsible for handling (generating/sending/receiving) signalling between the DU 61 and other nodes or units, such as the RU 60 and other nodes and units.

The DU 61 may support the Non-Public Network (NPN), The NPN may be a Stand-alone Non-Public Network (SNPN) or a Public Network Integrated NPN (PNI-NPN).

As described above, the RU 60 can be integrated/combined with the DU 61 or CU 62 as an integrated/combined unit. Any functionality in the description for DU 61 can be implemented in one of the integrated/combined unit above.

### <Centralized Unit (CU)>

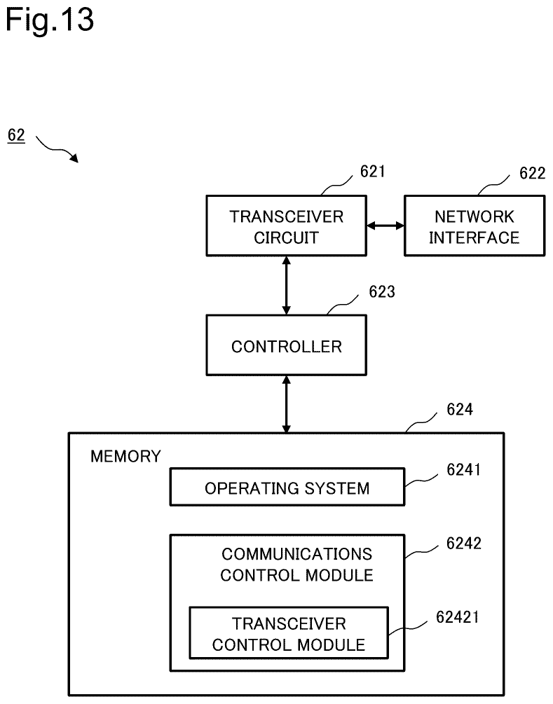

FIG. 13 is a block diagram illustrating the main components of an exemplary CU 62, for example a CU part of base station (‘eNB’ in LTE, ‘gNB’ in 5G, a base station for 5G beyond, a base station for 6G). As shown, the apparatus includes a transceiver circuit 621 which is operable to transmit signals to and to receive signals from other nodes or units (including the DU 61) via a network interface 622. A controller 623 controls the operation of the CU 62 in accordance with software stored in a memory 624. Software may be pre-installed in the memory 624 and/or may be downloaded via the telecommunication network or from a removable data storage device (RMD), for example. The software includes, among other things, an operating system 6241 and a communications control module 6242 having at least a transceiver control module 62421. The communications control module 6242 (using its transceiver control module 62421 is responsible for handling (generating/sending/receiving) signalling between the CU 62 and other nodes or units, such as the DU 61 and other nodes and units.

The CU 62 may support the Non-Public Network (NPN), The NPN may be a Stand-alone Non-Public Network (SNPN) or a Public Network Integrated NPN (PNI-NPN).

As described above, the CU 62 can be integrated/combined with the DU 61 as an integrated/combined unit. Any functionality in the description for the CU 62 can be implemented in the integrated/combined unit above.

### <AMF>

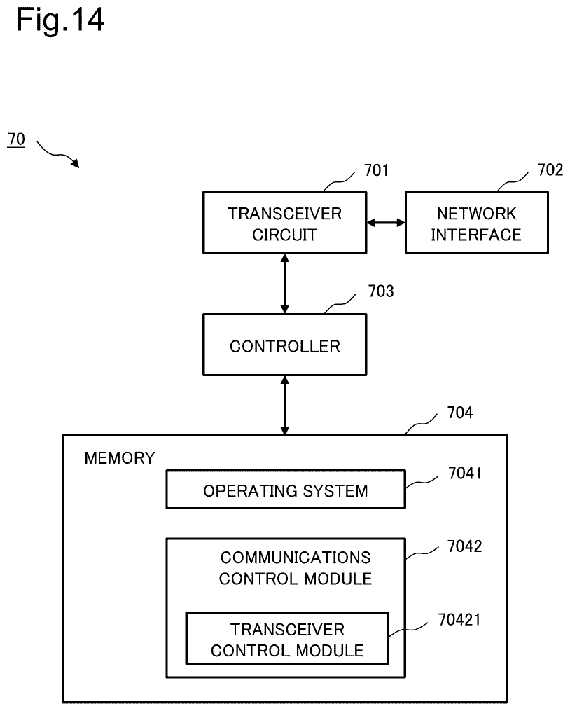

FIG. 14 is a block diagram illustrating the main components of the AMF 70. As shown, the apparatus includes a transceiver circuit 701 which is operable to transmit signals to and to receive signals from other nodes (including the UE 3) via a network interface 702. A controller 703 controls the operation of the AMF 70 in accordance with software stored in a memory 704. Software may be pre-installed in the memory 704 and/or may be downloaded via the telecommunication network or from a removable data storage device (RMD), for example. The software includes, among other things, an operating system 7041 and a communications control module 7042 having at least a transceiver control module 70421. The communications control module 7042 (using its transceiver control module 70421 is responsible for handling (generating/sending/receiving) signalling between the AMF 70 and other nodes, such as the UE 3 (e.g. via the (R)AN node 5) and other core network nodes (including core network nodes in the HPLMN of the UE 3 when the UE 3 is roaming-in. Such signalling may include, for example, appropriately formatted signalling messages (e.g. a registration request message and associated response messages) relating to access and mobility management procedures (for the UE 3).

The AMF 70 may support the Non-Public Network (NPN), The NPN may be a Stand-alone Non-Public Network (SNPN) or a Public Network Integrated NPN (PNI-NPN).

### <SMF>

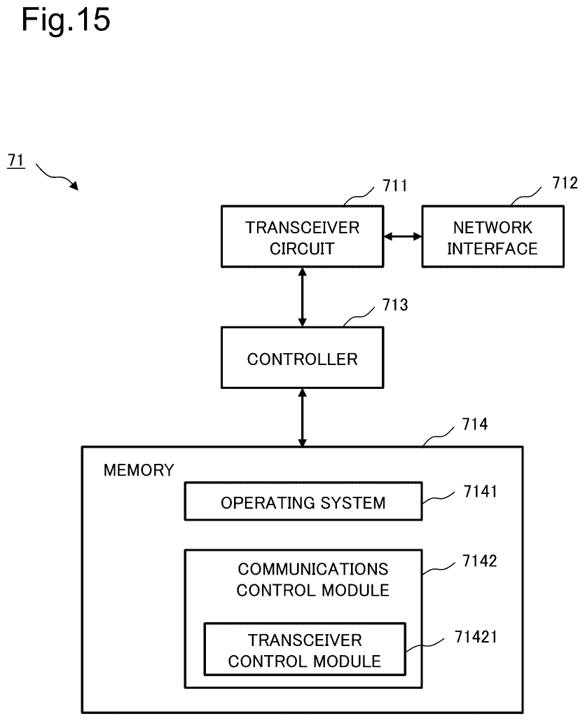

FIG. 15 is a block diagram illustrating the main components of the SMF 71. As shown, the apparatus includes a transceiver circuit 711 which is operable to transmit signals to and to receive signals from other nodes (including the AMF 70) via a network interface 712. A controller 713 controls the operation of the SMF 71 in accordance with software stored in a memory 714. Software may be pre-installed in the memory 714 and/or may be downloaded via the telecommunication network or from a removable data storage device (RMD), for example. The software includes, among other things, an operating system 7141 and a communications control module 7142 having at least a transceiver control module 71421. The communications control module 7142 (using its transceiver control module 71421 is responsible for handling (generating/sending/receiving) signalling between the SMF 71 and other nodes, such as the UPF 72 and other core network nodes (including core network nodes in the HPLMN of the UE 3 when the UE 3 is roaming-in. Such signalling may include, for example, appropriately formatted signalling messages (e.g. a Hypertext Transfer Protocol (HTTP) restful methods based on the service based interfaces) relating to session management procedures (for the UE 3).

The SMF 71 may support the Non-Public Network (NPN), The NPN may be a Stand-alone Non-Public Network (SNPN) or a Public Network Integrated NPN (PNI-NPN).

### <UPF>

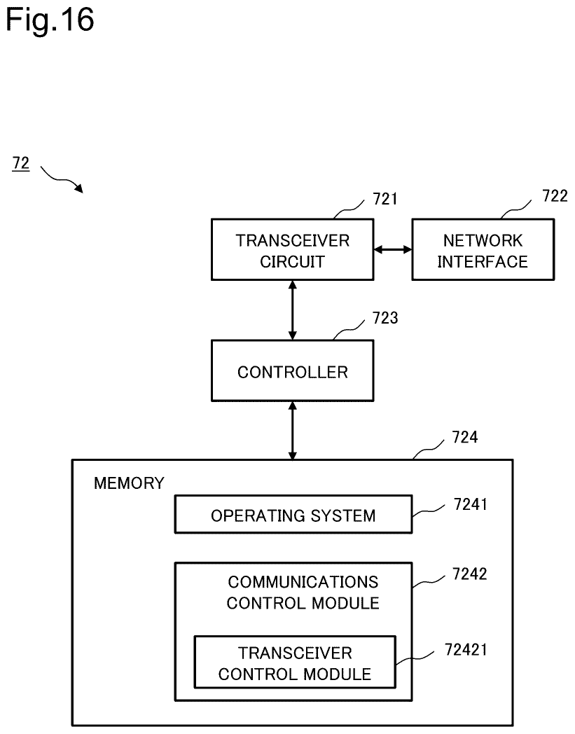

FIG. 16 is a block diagram illustrating the main components of the UPF 72. As shown, the apparatus includes a transceiver circuit 721 which is operable to transmit signals to and to receive signals from other nodes (including the SMF 71) via a network interface 722. A controller 723 controls the operation of the UPF 72 in accordance with software stored in a memory 724. Software may be pre-installed in the memory 724 and/or may be downloaded via the telecommunication network or from a removable data storage device (e.g. a removable memory device (RMD)), for example. The software includes, among other things, an operating system 7241 and a communications control module 7242 having at least a transceiver control module 72421. The communications control module 7242 (using its transceiver control module 72421 is responsible for handling (generating/sending/receiving) signalling between the UPF 72 and other nodes, such as the SMF 71 and other core network nodes (including core network nodes in the HPLMN of the UE 3 when the UE 3 is roaming-in. Such signalling may include, for example, appropriately formatted signalling messages (e.g. a GPRS Tunneling Protocol (GTP) for User plane) relating to User data handling (for the UE 3).

The UPF 72 may support the Non-Public Network (NPN), The NPN may be a Stand-alone Non-Public Network (SNPN) or a Public Network Integrated NPN (PNI-NPN).

The collocated gNB-CU-UP and UPF or the communication apparatus executing function of a collocated gNB-CU-UP and UPF or the communication apparatus executing function of the gNB-CU-UP and function of the UPF may have same components to the UPF 72.

### <PCF>

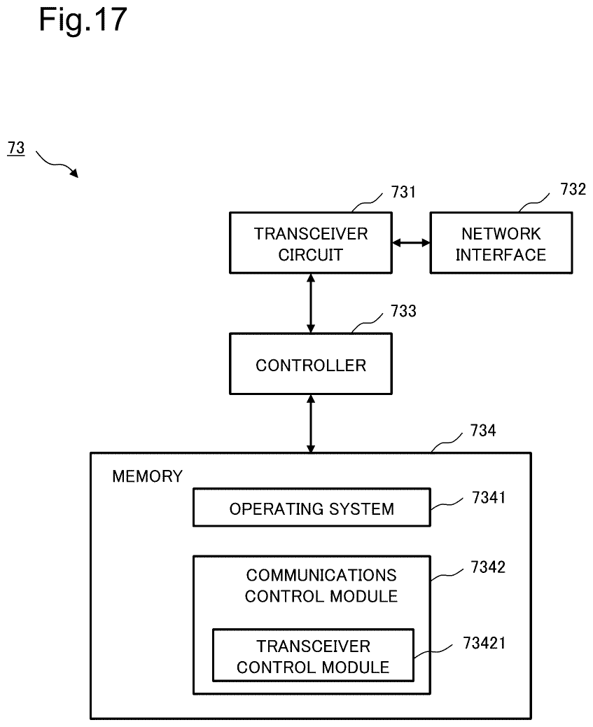

FIG. 17 is a block diagram illustrating the main components of the PCF 73. As shown, the apparatus includes a transceiver circuit 731 which is operable to transmit signals to and to receive signals from other nodes (including the AMF 70) via a network interface 732. A controller 733 controls the operation of the PCF 73 in accordance with software stored in a memory 734. Software may be pre-installed in the memory 734 and/or may be downloaded via the telecommunication network or from a removable data storage device (e.g. a removable memory device (RMD)), for example. The software includes, among other things, an operating system 7341 and a communications control module 7342 having at least a transceiver control module 73421. The communications control module 7342 (using its transceiver control module 73421 is responsible for handling (generating/sending/receiving) signalling between the PCF 73 and other nodes, such as the AMF 70 and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to policy management procedures (for the UE 3).

The PCF 73 may support the Non-Public Network (NPN), The NPN may be a Stand-alone Non-Public Network (SNPN) or a Public Network Integrated NPN (PNI-NPN).

### <AUSF>

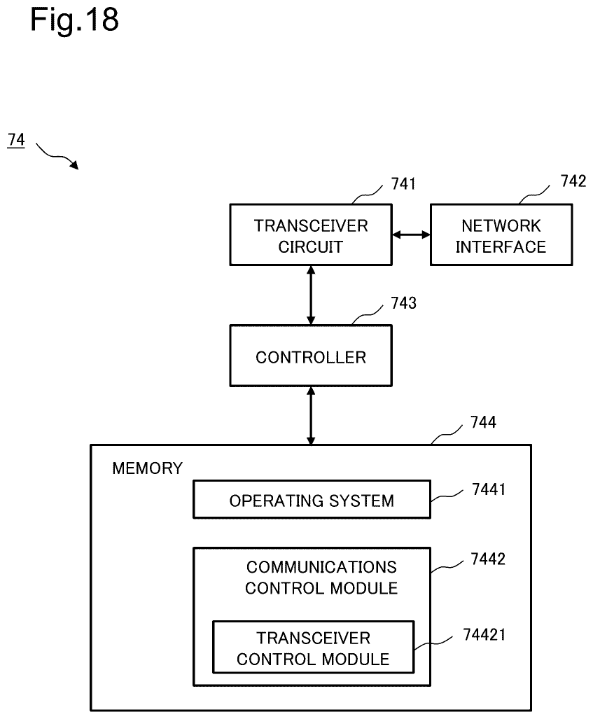

FIG. 18 is a block diagram illustrating the main components of the AUSF 74. As shown, the apparatus includes a transceiver circuit 741 which is operable to transmit signals to and to receive signals from other nodes (including the UDM 75) via a network interface 742. A controller 743 controls the operation of the AUSF 74 in accordance with software stored in a memory 744. Software may be pre-installed in the memory 744 and/or may be downloaded via the telecommunication network or from a removable data storage device (e.g. a removable memory device (RMD)), for example. The software includes, among other things, an operating system 7441 and a communications control module 7442 having at least a transceiver control module 74421. The communications control module 7442 (using its transceiver control module 74421 is responsible for handling (generating/sending/receiving) signalling between the AUSF 74 and other nodes, such as the AMF 70 and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to policy management procedures (for the UE 3).

The AUSF 74 may support the Non-Public Network (NPN), The NPN may be a Stand-alone Non-Public Network (SNPN) or a Public Network Integrated NPN (PNI-NPN).

### <UDM>

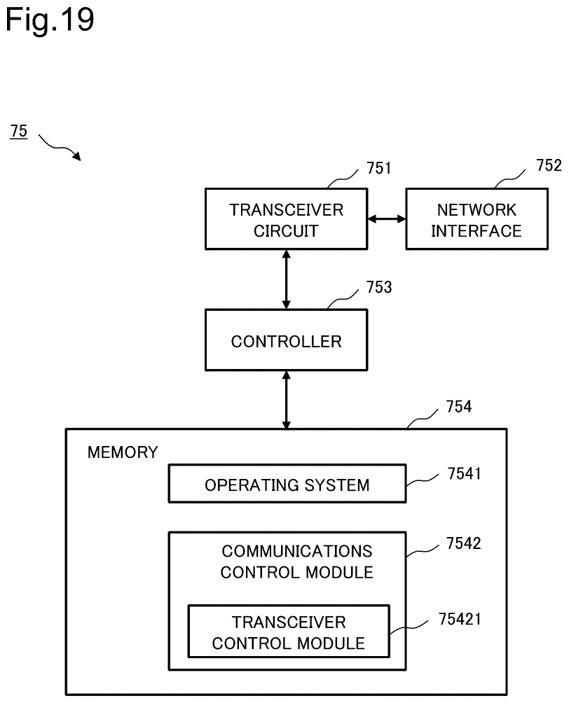

FIG. 19 is a block diagram illustrating the main components of the UDM 75. As shown, the apparatus includes a transceiver circuit 751 which is operable to transmit signals to and to receive signals from other nodes (including the AMF 70) via a network interface 752. A controller 753 controls the operation of the UDM 75 in accordance with software stored in a memory 754. Software may be pre-installed in the memory 754 and/or may be downloaded via the telecommunication network or from a removable data storage device (RMD), for example. The software includes, among other things, an operating system 7541 and a communications control module 7542 having at least a transceiver control module 75421. The communications control module 7542 (using its transceiver control module 75421 is responsible for handling (generating/sending/receiving) signalling between the UDM 75 and other nodes, such as the AMF 70 and other core network nodes (including core network nodes in the VPLMN of the UE 3 when the UE 3 is roaming-out. Such signalling may include, for example, appropriately formatted signalling messages (e.g. a HTTP restful methods based on the service based interfaces) relating to mobility management procedures (for the UE 3).

The UDM 75 may support the Non-Public Network (NPN), The NPN may be a Stand-alone Non-Public Network (SNPN) or a Public Network Integrated NPN (PNI-NPN).

### <NWDAF>

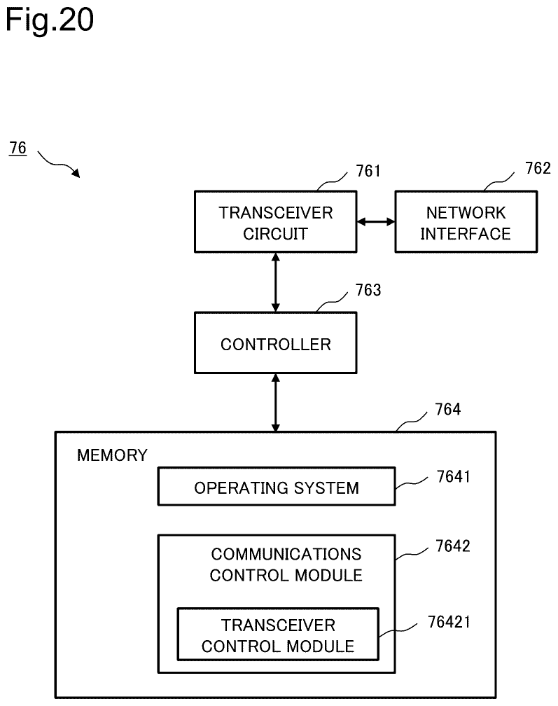

FIG. 20 is a block diagram illustrating the main components of the NWDAF 76. As shown, the apparatus includes a transceiver circuit 761 which is operable to transmit signals to and to receive signals from other nodes (including the AMF 70) via a network interface 762. A controller 763 controls the operation of the NWDAF 76 in accordance with the software stored in a memory 764. The Software may be pre-installed in the memory 764 and/or may be downloaded via the telecommunication network or from a removable data storage device (e.g. a removable memory device (RMD)), for example. The software includes, among other things, an operating system 7641 and a communications control module 7642 having at least a transceiver control module 76421. The communications control module 7642 (using its transceiver control module 76421 is responsible for handling (generating/sending/receiving) signalling between the NWDAF 76 and other nodes, such as the AMF 70 and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to network data analytics function procedures (for the UE 3).

The NWDAF 76 may support the Non-Public Network (NPN), The NPN may be a Stand-alone Non-Public Network (SNPN) or a Public Network Integrated NPN (PNI-NPN).

### <NEF>

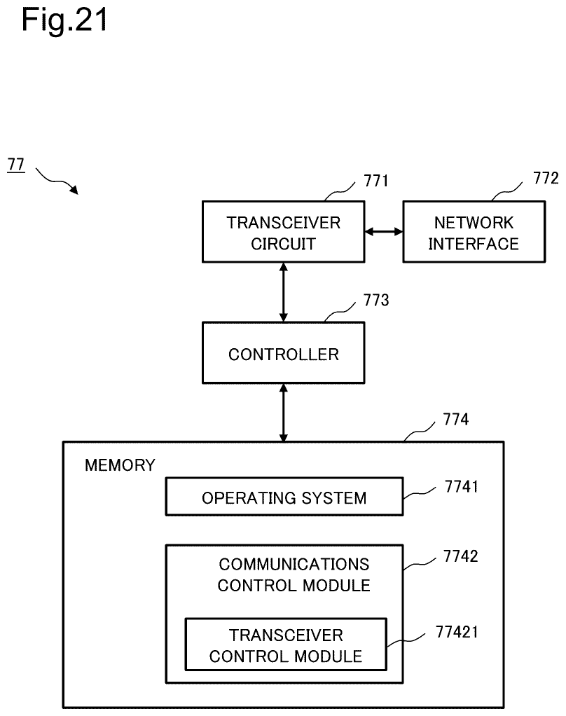

FIG. 21 is a block diagram illustrating the main components of the NEF 77. As shown, the apparatus includes a transceiver circuit 771 which is operable to transmit signals to and to receive signals from other nodes (including the UDM 75) via a network interface 772. A controller 773 controls the operation of the NEF 77 in accordance with software stored in a memory 774. Software may be pre-installed in the memory 774 and/or may be downloaded via the telecommunication network or from a removable data storage device (e.g. a removable memory device (RMD)), for example. The software includes, among other things, an operating system 7741 and a communications control module 7742 having at least a transceiver control module 77421. The communications control module 7742 (using its transceiver control module 77421 is responsible for handling (generating/sending/receiving) signalling between the NEF 77 and other nodes, such as the UDM 75 and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to network exposure function procedures (for the UE 3).

The NEF 77 may support the Non-Public Network (NPN), The NPN may be a Stand-alone Non-Public Network (SNPN) or a Public Network Integrated NPN (PNI-NPN).

### <NSACF>

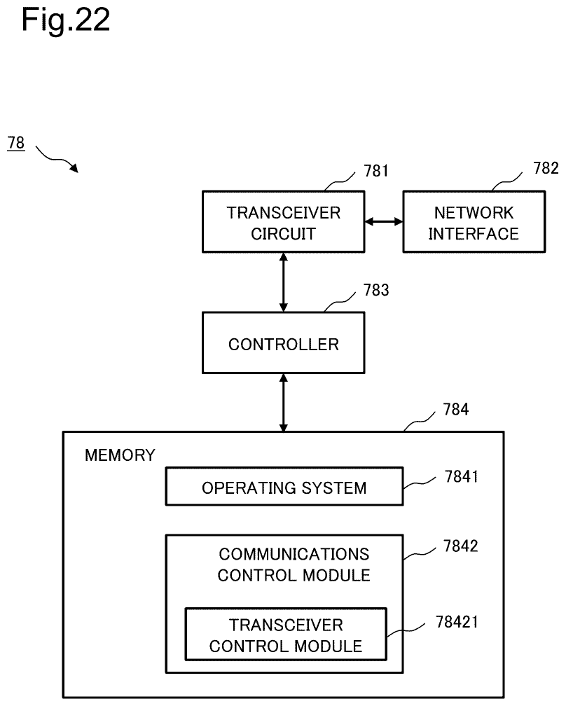

FIG. 22 is a block diagram illustrating the main components of the NSACF 78. As shown, the apparatus includes a transceiver circuit 781 which is operable to transmit signals to and to receive signals from other nodes (including the AMF 70) via a network interface 782. A controller 783 controls the operation of the NSACF 78 in accordance with the software stored in a memory 784. The Software may be pre-installed in the memory 784 and/or may be downloaded via the telecommunication network or from a removable data storage device (RMD), for example. The software includes, among other things, an operating system 7841 and a communications control module 7842 having at least a transceiver control module 78421. The communications control module 7842 (using its transceiver control module 78421 is responsible for handling (generating/sending/receiving) signalling between the NSACF 78 and other nodes, such as the AMF 70 and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to network data analytics function procedures (for the UE 3).

The NSACF 78 may support the Non-Public Network (NPN), The NPN may be a Stand-alone Non-Public Network (SNPN) or a Public Network Integrated NPN (PNI-NPN).

### <AF>

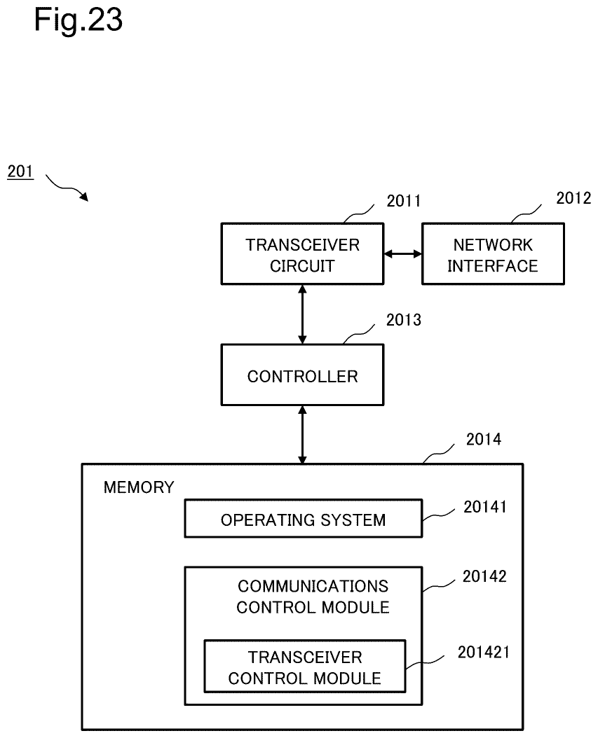

FIG. 23 is a block diagram illustrating the main components of the AF 201. As shown, the apparatus includes a transceiver circuit 2011 which is operable to transmit signals to and to receive signals from other nodes (including the NEF 77) via a network interface 2012. A controller 2013 controls the operation of the AF 201 in accordance with software stored in a memory 2014. Software may be pre-installed in the memory 2014 and/or may be downloaded via the telecommunication network or from a removable data storage device (RMD), for example. The software includes, among other things, an operating system 20141 and a communications control module 20142 having at least a transceiver control module 201421. The communications control module 20142 (using its transceiver control module 201421 is responsible for handling (generating/sending/receiving) signalling between the AF 201 and other nodes, such as the NEF 77 and other core network nodes (including core network nodes in the VPLMN of the UE 3 when the UE 3 is roaming-out. Such signalling may include, for example, appropriately formatted signalling messages (e.g. a HTTP restful methods based on the service based interfaces) relating to mobility management procedures (for the UE 3).

The AF 201 may support the Non-Public Network (NPN), The NPN may be a Stand-alone Non-Public Network (SNPN) or a Public Network Integrated NPN (PNI-NPN).

### Modifications and Alternatives

Detailed aspects have been described above. As those skilled in the art will appreciate, a number of modifications and alternatives can be made to the above aspects whilst still benefiting from the disclosures embodied therein. By way of illustration only a number of these alternatives and modifications will now be described.

In the above description, the UE 3 and the network apparatus are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example; one or more hardware implemented computer processors; microprocessors: central processing units (CPUs): arithmetic logic units (ALUs): input/output (IO) circuits; internal memories/caches (program and/or data): processing registers: communication buses (e.g. control, data and/or address buses): direct memory access (DMA) functions: hardware or software implemented counters, pointers and/or timers; and/or the like.

In the above aspects, a number of software modules were described. As those skilled in the art will appreciate, the software modules may be provided in compiled or un-compiled form and may be supplied to the UE 3 and the network apparatus as a signal over a computer network, or on a recording medium. Further, the functionality performed by part or all of this software may be performed using one or more dedicated hardware circuits. However, the use of software modules is preferred as it facilitates the updating of the UE 3 and the network apparatus in order to update their functionalities.

In the above aspects, a 3GPP radio communications (radio access) technology is used. However, any other radio communications technology (e.g. WLAN, Wi-Fi, WiMAX, Bluetooth, etc.) and other fix line communications technology (e.g. BBF Access, Cable Access, optical access, etc.) may also be used in accordance with the above aspects.

Items of user equipment might include, for example, communication devices such as mobile telephones, smartphones, user equipment, personal digital assistants, laptop/tablet computers, web browsers, e-book readers and/or the like. Such mobile (or even generally stationary) devices are typically operated by a user, although it is also possible to connect so-called ‘Internet of Things’ (IoT) devices and similar machine-type communication (MTC) devices to the network. For simplicity, the present application refers to mobile devices (or UEs) in the description but it will be appreciated that the technology described can be implemented on any communication devices (mobile and/or generally stationary) that can connect to a communications network for sending/receiving data, regardless of whether such communication devices are controlled by human input or software instructions stored in memory.

Various other modifications will be apparent to those skilled in the art and will not be described in further detail here.

As will be appreciated by one of skill in the art, the present disclosure may be embodied as a method, and system. Accordingly, the present disclosure may take the form of an entirely hardware embodiment, a software embodiment or an embodiment combining software and hardware aspects.

It will be understood that each block of the block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. A general-purpose processor may be a microprocessor, but in the alternative, the processor may be any conventional processor, controller, microcontroller, or state machine. A processor may also be implemented as a combination of computing devices, e.g., a plurality of microprocessors, one or more microprocessors, or any other such configuration.

The methods or algorithms described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC.

The previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

While the disclosure has been particularly shown and described with reference to exemplary Aspects thereof, the disclosure is not limited to these Aspects. It will be understood by those of ordinary skill in the art that various changes in form and details may be made therein without departing from the spirit and scope of the present disclosure as defined by this document. For example, the Aspects above are not limited to 5GS, and the Aspects are also applicable to communication system other than 5GS (e.g., 6G system, 5G beyond system).

### SUPPLEMENTARY NOTES

The whole or part of the example Aspects disclosed above can be described as, but not limited to, the following supplementary notes.

supplementary note 1. A method of a communication apparatus, the method comprising:
sending information for requesting a URSP (User Equipment Route Selection Policy) rule; and
receiving the URSP rule in a case of sending the information.

supplementary note 2. The method according to supplementary note 1,
wherein the communication apparatus is an Application Function (AF) apparatus.

supplementary note 3. The method according to supplementary note 1,
wherein the communication apparatus is a Network Exposure Function (NEF) apparatus.

supplementary note 4. The method according to supplementary note 1,
wherein the communication apparatus is a Network Data Analytics Function (NWDAF) apparatus.

supplementary note 5. The method according to supplementary note 1,
wherein the communication apparatus is an Access and Mobility Management Function (AMF) apparatus.

supplementary note 6. The method according to supplementary note 1,
wherein the communication apparatus is a Policy Control Function (PCF) apparatus.

supplementary note 7. A method of a User Equipment (UE), the method comprising:
receiving information for requesting a URSP (User Equipment Route Selection Policy) rule; and
sending the URSP rule in a case of receiving the information.

supplementary note 8. A method of a communication apparatus, the method comprising:
receiving information for requesting a URSP (User Equipment Route Selection Policy) rule; and
sending the URSP rule in a case of receiving the information.

supplementary note 9. The method according to supplementary note 8,
wherein the communication apparatus is a Policy Control Function (PCF) apparatus.

supplementary note 10. A method of a communication apparatus, the method comprising:
sending information to request monitoring of a traffic routing; and
receiving a result of the monitoring of the traffic routing in a case of sending the information.

supplementary note 11. The method according to supplementary note 10,
wherein the communication apparatus is an Application Function (AF) apparatus.

supplementary note 12. A method of a communication apparatus, the method comprising:
receiving information to request monitoring of a traffic routing;
performing validity check for a URSP (User Equipment Route Selection Policy) rule after receiving the information; and
sending information to monitor the traffic routing in a case where the validity check completes successfully.

supplementary note 13. The method according to supplementary note 12,
sending a reject cause in a case where the validity check fails.

supplementary note 14. The method according to supplementary note 12 or 13,
wherein the communication apparatus is a Policy Control Function (PCF) apparatus.

supplementary note 15. A method of a communication apparatus, the method comprising:
receiving information to monitor a traffic routing;
monitoring the traffic routing based on the information; and sending a result of the monitoring of the traffic routing.

supplementary note 16. The method according to supplementary note 15,
wherein the communication apparatus is a Network Data Analytics Function (NWDAF) apparatus.

supplementary note 17. The method according to supplementary note 15,
wherein the communication apparatus is a Network Slice Admission Control Function (NSACF) apparatus.

supplementary note 18. A method of a communication apparatus, the method comprising:
receiving a result of a monitoring of a traffic routing; and sending the result.

supplementary note 19. The method according to supplementary note 18,
wherein the communication apparatus is a Network Exposure Function (NEF) apparatus.

supplementary note 20. A method of a User Equipment (UE), the method comprising:
sending a Protocol Data Unit (PDU) Session Establishment Request message,
wherein the PDU Session Establishment Request message includes Data Network Name (DNN), Single Network Slice Selection Assistance Information (S-NSSAI) and identifier of an application that the UE requests a service; and
receiving a PDU Session Establishment Reject message,
wherein the PDU Session Establishment Reject message includes a reject cause indicating that the UE or the application is not entitled for the service on the S-NSSAI and the DNN.

supplementary note 21. A communication apparatus comprising:
means for sending information for requesting a URSP (User Equipment Route Selection Policy) rule; and
means for receiving the URSP rule in a case of sending the information.

supplementary note 22. The communication apparatus according to supplementary note 21,
wherein the communication apparatus is an Application Function (AF) apparatus.

supplementary note 23. The communication apparatus according to supplementary note 21,
wherein the communication apparatus is a Network Exposure Function (NEF) apparatus.

supplementary note 24. The communication apparatus according to supplementary note 21,
wherein the communication apparatus is a Network Data Analytics Function (NWDAF) apparatus.

supplementary note 25. The communication apparatus according to supplementary note 21,
wherein the communication apparatus is an Access and Mobility Management Function (AMF) apparatus.

supplementary note 26. The communication apparatus according to supplementary note 21,
wherein the communication apparatus is a Policy Control Function (PCF) apparatus.

supplementary note 27. A User Equipment (UE) comprising: means for receiving information for requesting a URSP (User Equipment Route Selection Policy) rule; and
means for sending the URSP rule in a case of receiving the information.

supplementary note 28. A communication apparatus comprising:
means for receiving information for requesting a URSP (User Equipment Route Selection Policy) rule; and
means for sending the URSP rule in a case of receiving the information.

supplementary note 29. The communication apparatus according to supplementary note 28,
wherein the communication apparatus is a Policy Control Function (PCF) apparatus.

supplementary note 30. A communication apparatus comprising:
means for sending information to request monitoring of a traffic routing; and
means for receiving a result of the monitoring of the traffic routing in a case of sending the information.

supplementary note 31. The communication apparatus according to supplementary note 30,
wherein the communication apparatus is an Application Function (AF) apparatus.

supplementary note 32. A communication apparatus comprising:
means for receiving information to request monitoring of a traffic routing;
means for performing validity check for a URSP (User Equipment Route Selection Policy) rule after receiving the information; and
means for sending information to monitor the traffic routing in a case where the validity check completes successfully.

supplementary note 33. The communication apparatus according to supplementary note 32, further comprising:
means for sending a reject cause in a case where the validity check fails.

supplementary note 34. The communication apparatus according to supplementary note 32 or 33,
wherein the communication apparatus is a Policy Control Function (PCF) apparatus.

supplementary note 35. A communication apparatus comprising:
means for receiving information to monitor a traffic routing;
means for monitoring the traffic routing based on the information; and
means for sending a result of the monitoring of the traffic routing.

supplementary note 36. The communication apparatus according to supplementary note 35,
wherein the communication apparatus is a Network Data Analytics Function (NWDAF) apparatus.

supplementary note 37. The communication apparatus according to supplementary note 35,
wherein the communication apparatus is a Network Slice Admission Control Function (NSACF) apparatus.

supplementary note 38. A communication apparatus comprising:
means for receiving a result of a monitoring of a traffic routing; and
means for sending the result.

supplementary note 39. The communication apparatus according to supplementary note 38,
wherein the communication apparatus is a Network Exposure Function (NEF) apparatus.

supplementary note 40. A User Equipment (UE) comprising:
means for sending a Protocol Data Unit (PDU) Session Establishment Request message,
wherein the PDU Session Establishment Request message includes Data Network Name (DNN), Single Network Slice Selection Assistance Information (S-NSSAI) and identifier of an application that the UE requests a service; and
means for receiving a PDU Session Establishment Reject message,
wherein the PDU Session Establishment Reject message includes a reject cause indicating that the UE or the application is not entitled for the service on the S-NSSAI and the DNN.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Indian provisional patent application No. 202211004542, filed on Jan. 27, 2022, the disclosure of which is incorporated herein in its entirety by reference.

### REFERENCE SIGNS LIST

1 telecommunication system
3 UE
5 (R)AN node
7 core network
20 data network
31 transceiver circuit
32 antenna
33 controller
34 user interface
35 USIM
36 memory
51 transceiver circuit
52 antenna
53 network interface
54 controller
55 memory
60 RU
61 DU
62 CU
70 AMF
71 SMF
72 UPF
73 PCF
74 AUSF
75 UDM
76 NWDAF
77 NEF
78 NSACF
201 AF
361 operating system
362 communications control module
551 operating system
552 communications control module
601 transceiver circuit
602 antenna
603 network interface
604 controller
605 memory
611 transceiver circuit
612 network interface
613 controller
614 memory
621 transceiver circuit
622 network interface
623 controller
624 memory
701 transceiver circuit
702 network interface
703 controller
704 memory
711 transceiver circuit
712 network interface
713 controller
714 memory
721 transceiver circuit
722 network interface
723 controller
724 memory
731 transceiver circuit
732 network interface
733 controller
734 memory
741 transceiver circuit
742 network interface
743 controller
744 memory
751 transceiver circuit
752 network interface
753 controller
754 memory
761 transceiver circuit
762 network interface
763 controller
764 memory
771 transceiver circuit
772 network interface
773 controller
774 memory
781 transceiver circuit
782 network interface
783 controller
784 memory
2011 transceiver circuit
2012 network interface
2013 controller
2014 memory
3621 transceiver control module
5521 transceiver control module
6051 operating system
6052 communications control module
6141 operating system
6142 communications control module
6241 operating system
6242 communications control module
7041 operating system
7042 communications control module
7141 operating system
7142 communications control module
7241 operating system
7242 communications control module
7341 operating system
7342 communications control module
7441 operating system
7442 communications control module
7541 operating system
7542 communications control module
7641 operating system
7642 communications control module
7741 operating system
7742 communications control module
7841 operating system
7842 communications control module
20141 operating system
20142 communications control module
60521 transceiver control module
61421 transceiver control module
62421 transceiver control module
70421 transceiver control module
71421 transceiver control module
72421 transceiver control module
73421 transceiver control module
74421 transceiver control module
75421 transceiver control module
76421 transceiver control module
77421 transceiver control module
78421 transceiver control module
201421 transceiver control module

What is claimed is:

1.-6. (canceled)

7. A method of a User Equipment (UE), the method comprising:
receiving first information related to a User Equipment Route Selection Policy (URSP) rule from a communication apparatus; and
sending second information related to an application and the URSP rule to the communication apparatus after the receiving the first information related to the URSP rule.

8.-11. (canceled)

12. A method of a communication apparatus, the method comprising:
receiving information from a User Equipment (UE); and
performing check related to a User Equipment Route Selection Policy (URSP) rule of the UE using a Protocol Data Unit (PDU) Session related parameter after the receiving the information.

13.-19. (canceled)

20. A method of a User Equipment (UE), the method comprising:
sending a Protocol Data Unit (PDU) Session Establishment Request message to a communication apparatus, the PDU Session Establishment Request message including a parameter related to an application based on the UE associating the application to a PDU Session; and
after the sending the PDU Session Establishment Request message, receiving a PDU Session Establishment Reject message from the communication apparatus, the PDU Session Establishment Reject message including a reject cause.

21.-26. (canceled)

27. A User Equipment (UE) comprising:
one or more memories storing instructions; and
one or more processors configured to execute the instructions to:
receive first information related to a User Equipment Route Selection Policy (URSP) rule from a communication apparatus, and
send second information related to an application and the URSP rule to the communication apparatus after the first information related to the URSP rule being received.

28.-31. (canceled)

32. A communication apparatus comprising:
one or more memories storing instructions; and
one or more processors configured to execute the instructions to:
receive information from a User Equipment (UE); and
perform check related to a User Equipment Route Selection Policy (URSP) rule of the UE using a Protocol Data Unit (PDU) Session related parameter after the information being received.

33.-39. (canceled)

40. A User Equipment (UE) comprising:
one or more memories storing instructions; and
one or more processors configured to execute the instructions to:
send a Protocol Data Unit (PDU) Session Establishment Request message to a communication apparatus, the PDU Session Establishment Request message including parameter related to an application based on the UE associating the application to a PDU Session, and
after the PDU Session Establishment Request message being sent, receive a PDU Session Establishment Reject message from the communication apparatus, the PDU Session Establishment Reject message including a reject cause.

41. The method according to claim 12, comprising:
adjusting the URSP rule of the UE based on determining that the UE does not have up-to-date URSP rule after the receiving the information.

42. The method according to claim 41, comprising:
updating the UE with the adjusted URSP rule of the UE.

43. The method according to claim 42, wherein the communication apparatus is a Policy Control Function (PCF) apparatus.

44. The communication apparatus according to claim 32, wherein the one or more processors are configured to execute the instructions to
adjust the URSP rule of the UE based on determining that the UE does not have up-to-date URSP rule after the information being received.

45. The communication apparatus according to claim 44, wherein the one or more processors are configured to execute the instructions to
update the UE with the adjusted URSP rule of the UE.

46. The communication apparatus according to claim 45, wherein the communication apparatus is a Policy Control Function (PCF) apparatus.

47. The method according to claim 20, wherein the communication apparatus is a core network apparatus.

48. The UE according to claim 27, wherein the communication apparatus is a core network apparatus.

49. The method according to claim 47, wherein the core network apparatus is a Session Management Function (SMF) apparatus or an Access and Mobility Management Function (AMF) apparatus.

50. The UE according to claim 48, wherein the core network apparatus is a Session Management Function (SMF) apparatus or an Access and Mobility Management Function (AMF) apparatus.
